(19) United States
(12) Patent Application Publication
(10) Pub. No.: US 2026/0205601 A1
(43) Pub. Date: Jul. 16, 2026

(54) GEOMETRIC MOTION VECTOR DERIVATION

(71) Applicant: Fraunhofer-Gesellschaft zur Foerderung der angewandten Forschung e.V., Munich (DE)

(72) Inventors: Tobias HINZ, Berlin (DE); Philipp HELLE, Berlin (DE); Philipp MERKLE, Berlin (DE); Martin WINKEN, Berlin (DE); Heiko SCHWARZ, Berlin (DE); Jonathan PFAFF, Berlin (DE); Detlev MARPE, Berlin (DE); Thomas WIEGAND, Berlin (DE)

(21) Appl. No.: 19/559,036

(22) Filed: Mar. 6, 2026

Related U.S. Application Data
(63) Continuation of application No. PCT/EP2024/074589, filed on Sep. 3, 2024.

(30) Foreign Application Priority Data
Sep. 6, 2023 (EP) 23195847.1

(51) Int. Cl. H04N 19/139; H04N 19/105; H04N 19/176; H04N 19/503; H04N 19/70

(52) U.S. Cl. CPC H04N 19/139; H04N 19/105; H04N 19/176; H04N 19/503; H04N 19/70

(57) ABSTRACT

Video decoder for decoding a video of a scene from a data stream using motion-compensated prediction, configured to derive, for a current block of a current picture, a predicted block inner by finding in a reference picture corresponding positions, corresponding to pixels in the current block, using video-geometry-related parameters describing how the scene is projected onto pictures of the video, and sampling the reference picture at the corresponding positions, and reconstruct the current block using the predicted block inner.

### CROSS-REFERENCE TO RELATED APPLICATIONS

This application is a continuation of copending International Application No. PCT/EP2024/074589, filed Sep. 3, 2024, which is incorporated herein by reference in its entirety, and additionally claims priority from European Application No. EP 23195847.1, filed Sep. 6, 2023, which is also incorporated herein by reference in its entirety.

Embodiments according to the invention related to apparatuses, i.e. video encoder and video decoder, and methods for encoding or decoding a video of a scene using motion-compensated prediction.

### BACKGROUND OF THE INVENTION

Hybrid video codecs partition the input signal frame wise into squared blocks called CTUs (Coded Tree Unit). The CTU can be sub-partitioned into smaller CUs (Coding Units). The reconstructed samples of a CU are composed by superimposing prediction samples and a residual signal transmitted in the bitstream, followed by multiple post filters that remove coding artifacts and thus improve the quality of the reconstructed samples. A picture order count (POC) is assigned to each picture, increasing with the display order.

For prediction of a CU two basic modes are distinguished: intra, that predicts samples from already reconstructed areas within the current picture, typically from the adjacent neighborhood; and inter using sample information from previously reconstructed pictures for temporal sample prediction, as well as a combination of both modes as combined inter intra prediction (CIIP). A special mode available for intra prediction is the intra block copy (IBC) mode that uses a displacement vector into the already reconstructed region of the current picture to copy the prediction samples from the resulting location.

In Inter prediction, CUs are predicted using one or more reference pictures by weighted super positioning. Previously reconstructed pictures that are used as reference pictures are accessed via reference picture lists (RPL), where the particular reference picture selected for prediction is accessed using a reference index (Ref-Idx) into the list. VVC uses up to two reference lists L0 and L1. The spatial offset of the position where the prediction samples are fetched from the reference picture relative to the position of the current block is determined by a motion vector (MV) with a resolution precision ranging from Nx sample- to subsample-resolution precision. For prediction from a sub-sample position, one of multiple N-tap interpolation filters is used according to the subsample position.

To exploit redundancies in the motion vector coding, each MV that is used to fetch the prediction sample from a reference picture is predicted by a motion vector predictor (MVP) derived by a motion vector prediction process. This process searches spatially and/or temporally neighboring CUs and/or a history based buffer for suitable MVP-candidates. The MVP-candidates are stored in a list and the MVP used to predict the MV is selected by an MVP-Index that is transmitted in the bitstream if not derived otherwise. The final MV is determined by superposition of the MVP and a motion vector difference (MVD) transmitted in the bitstream. For some coding modes like skip and some merge modes, no motion vector difference is transmitted in the bitstream and the final motion vector is derived directly from the MVP.

A more complex method for temporal sample prediction is called affine mode, using a multi-parameter affine prediction model to calculate the prediction samples. The affine mode uses two or three motion vectors at certain control points to describe a motion vector field that varies linearly with the sample position inside the current block.

A technique might be mentioned here that uses block-wise prediction weighting (BCW) for bi-prediction, where an index for each CU the BCW-Idx is used to address a scaling table that determines the individual weights applied to the hypothesis superimposed in bi-prediction.

Another technique is the merge mode with mv differences (MMVD), here an index is transmitted in the bitstream, that determines the direction and the spatial-distance of a motion vector with one of the vector components being zero.

A further technique is the symmetrical motion vector difference (SMVD), this mode is signaled in the bitstream if Bi-prediction is used for the current CU and the mode is not merge or skip. In this special mode the MVP-Idx of both RPL but only the MVD for the RPL L₀ are transmitted in the bitstream. The MVD applied to the MV predicting from the L₁ hypothesis is derived by copy the MVD transmitted for L₀ and inverting the sign of the MVD component-wise. The reference pictures are selected from the L₀ and L₁ list, that the reference picture from L₀ is directly preceding and the reference picture from L₁ is directly succeeding the current picture, in display order, among the reference stored in the respectively RPL.

Another inter prediction mode is called geometric partitioning mode (GPM) and uses two motion vectors per CU. The area covered by the CU is split tangentially into two regions. The final prediction samples are obtained by applying a pixelwise weighting matrix to the samples of the two prediction hypothesis, that performs blending at the region boundary from one prediction hypothesis into the other.

As stated before, the output of the MVP derivation process delivers an MVP candidate list with a fixed size where the final MVP is selected from the list using an MVP-Index that is transmitted in the bitstream.

The MVP derivation differs in details for the respective inter modes.

The merge candidate list-generation produces a single candidate list of N MVP-candidates comprising joint information for prediction from either one or both hypothesis (MVs and Ref-Idx for both RPL and a BCW-Idx per candidate).

For merge and skip mode the direct spatial neighborhood is scanned for possible MV candidates. If a candidate is found, the MVs, Ref-Idx for both reference lists, and the BCW-Idx are copied into the candidate list, unless it is already stored in the list. If the candidate list is not completed, a candidate using temporal motion vector prediction (TMVP) from a previously coded reference picture might be considered, unless it is already stored in the list. Thereafter, if the candidate list is not completely filled, a history based motion vector candidate (HMVP) is considered, unless it is already stored in the list. If the number of MVP candidates in the list is still smaller than the list size MVP candidates are constructed from available data and finally the list is filled up with zero motion vector candidates.

The AMVP list-generation process produces a candidate list with two MVPs candidates for a particular RPL and a given Ref-Idx. Therefore, at first spatial neighboring CUs are scanned for suitable candidates with the restriction that the candidate has to stem from the same RPL and has to have the same Ref-Idx as the current prediction hypothesis. If the candidate list contains less than two candidates, a TMVP candidate is considered. If the list still contains less than two candidates a HMVP-candidate is considered. If the list still does not contain two candidates it is filled up with zero motion candidates. To avoid duplicates, a suitable MVP-candidate is only inserted into the candidate list, if it is not already stored in the list.

Other state of the art coding modes include, Affine Merge, Affine Prediction, MER merge estimation region, DMVR and BIM/BDOF.

Temporal Scaling of motion is used to scale motion vectors that have been used for prediction from picture Pm in a previously coded reference picture Pn, assuming constant motion, depending on the POC differences between the picture Pm and its reference picture Pn, and the current target picture Pt and its reference picture Px.

The temporal motion vector prediction (TMVP) looks up a special reference picture in the L₁ RPL, that is used to access a co-located position and retrieve the corresponding motion information, if the according block was coded using an inter mode. The motion vector for a particular ref-list is scaled according to the ratio of the temporal distance derived from the POC differences of the co-located frame and the frame.

Temporal Scaling of motion vectors is applied when
Temporal motion vector prediction is used with co-located mv prediction.
MMVD is used to scale the motion vector differences according to the POC-distance between the target picture and the reference pictures.

Therefore, it is desired to provide concepts for rendering motion vector derivation more efficient and precise. Additionally or alternatively, it is desired to improve picture coding and/or video coding in order to reduce a bit stream and thus a signalization cost.

### SUMMARY

An embodiment may have a video decoder for decoding a video of a scene from a data stream using motion-compensated prediction, configured to
derive, for a current block of a current picture, a predicted block inner by
   finding in a reference picture corresponding positions, corresponding to pixels in the current block, using video-geometry-related parameters describing how the scene is projected onto pictures of the video, and
   sampling the reference picture at the corresponding positions; and
reconstruct the current block using the predicted block inner.

Another embodiment may have a video encoder for encoding a video of a scene into a data stream using motion-compensated prediction, configured to
derive, for a current block of a current picture, a predicted block inner by
   finding corresponding positions in a reference picture, corresponding to pixels in the current block, using video-geometry-related parameters describing how the scene is projected onto pictures of the video, and
   sampling the reference picture at the corresponding positions, and
encode the current block using the predicted block inner.

According to another embodiment, a method for decoding a video of a scene from a data stream using motion-compensated prediction may have the steps of:
deriving, for a current block of a current picture, a predicted block inner by
   finding in a reference picture corresponding positions, corresponding to pixels in the current block, using video-geometry-related parameters describing how the scene is projected onto pictures of the video, and
   sampling the reference picture at the corresponding positions, and
reconstructing the current block using the predicted block inner.

According to another embodiment, a method for encoding a video of a scene into a data stream using motion-compensated prediction may have the steps of:
deriving, for a current block of a current picture, a predicted block inner by
   finding corresponding positions in a reference picture, corresponding to pixels in the current block, using video-geometry-related parameters
   describing how the scene is projected onto pictures of the video, and
sampling the reference picture at the corresponding positions, and encode the current block using the predicted block inner.

Another embodiment may have a non-transitory digital storage medium storing a data stream generated by an inventive method for encoding.

In accordance with a first aspect of the present invention, the inventors of the present application realized that one problem encountered when trying to perform inter-prediction stems from the fact that the derivation of a motion vector involves finding for a current block a best matching block in a reference frame in an exhaustive search. According to the first aspect of the present application, this difficulty is overcome by using video-geometry-related parameters for deriving a predicted block inner from a reference picture. The video-geometry-related parameters describe how a scene is projected onto pictures of the video. The inventors found, that a knowledge about a projection of a scene onto a current picture and a projection of the scene onto a reference picture or a change of the projection between the two pictures, e.g., due to a change of a position and/or orientation of a camera capturing the video between capturing the reference picture and the current picture, can enhance an accuracy at inter-prediction. This is especially the case for static picture content, e.g., like a background, since the video-geometry-related parameters can reliably indicate positions in the reference picture, which correspond to pixels in the current block. Additionally, the inventors found that an encoding/decoding complexity can be reduced, since the video-geometry-related parameters indicate the projection of the scene onto the respective picture for the whole picture, for which reason it is not necessary to perform a computational intensive motion estimation for each inter-predicted block of the picture. Further, this also reduces a bit stream and thus a signalization cost, since the video-geometry-related parameters are signaled for the whole picture and do not have to be signaled for each block of the picture encoded/decoded using video-geometry-related parameters.

Accordingly, in accordance with a first aspect of the present application, a video decoder/encoder for decoding/encoding a video of a scene from/into a data stream using motion-compensated prediction, is configured to derive, for a current block of a current picture, a predicted block inner by finding in a (e.g. previously decoded/encoded; but not necessarily the immediately preceding one in terms of presentation time order) reference picture corresponding positions, corresponding to pixels in the current block, using video-geometry-related parameters, e.g., video-capturing-related parameters, describing how the scene is projected onto pictures of the video, and sampling the reference picture at the corresponding positions. The video decoder/encoder is configured to reconstruct/encode the current block using the predicted block inner, e.g., with respect to the decoder by means of adding to the predicted block inner a prediction residual decoded from the data stream or with respect to the encoder by means of subtracting the predicted block inner from an actual picture content within the current block to obtain a prediction residual and encode the prediction residual into the data stream. The video-geometry-related parameters may provide for one or more pictures of a video information of a position and an orientation of a camera capturing the respective picture and/or information of a position and/or an orientation of the respective picture relative to the scene. Therefore, the video-geometry-related parameters can also describe the projection of a scene onto pictures for a video that is synthetically generated by means of, for example, an artificial intelligence, a neural network or using 3D rendering.

In accordance with a second aspect of the present invention, the inventors of the present application realized that one problem encountered when trying to perform inter-prediction stems from the fact that the derivation of a motion vector involves finding for a current block a best matching block in a reference frame in an exhaustive search. According to the second aspect of the present application, this difficulty is overcome by using video-geometry-related parameters for deriving a motion vector. The video-geometry-related parameters describe how a scene is projected onto pictures of the video. The inventors found, that a knowledge about a projection of a scene onto a current picture and a projection of the scene onto a reference picture can enhance an accuracy at inter-prediction, wherein the projection of the scene onto the current picture and the projection of the scene onto the reference picture may differ in terms of a position and/or orientation of a camera capturing the respective picture. This increase in precision is especially the case for static picture content, e.g., like a background, since the video-geometry-related parameters can reliably indicate how the same scene point within the scene is projected onto the current picture and the reference picture allowing to efficiently and precisely derive a motion vector. Additionally, the inventors found that an encoding/decoding complexity can be reduced, since the video-geometry-related parameters indicate the projection of the scene onto the respective picture for the whole picture, for which reason it is not necessary to perform a computational intensive motion estimation for each inter-predicted block of the picture. Further, this also reduces a bit stream and thus a signalization cost, since the video-geometry-related parameters are signaled for the whole picture and do not have to be signaled for each block of the picture encoded/decoded using video-geometry-related parameters.

Accordingly, in accordance with a second aspect of the present application, a video decoder/encoder for decoding/encoding a video of a scene from/into a data stream using motion-compensated prediction, is configured to derive, for a current block, a predetermined motion vector predictor using video-geometry-related parameters describing how the scene is projected onto pictures of the video. The video decoder/encoder is configured to reconstruct/encode the current block using the predetermined MVP.

In accordance with a third aspect of the present invention, the inventors of the present application realized that one problem encountered when trying to inter predict samples of a predetermined block of a picture stems from the fact that a reference picture used for inter prediction is not always perfectly suitable for predicting samples of a current block. According to the third aspect of the present application, this difficulty is overcome by synthetically generating a reference picture instead of using an already decoded/encoded picture. The inventors found, that video-geometry-related parameters could be used to generate a synthesized reference picture matching with a current picture more than an already available reference picture. The video-geometry-related parameters describe how a scene is projected onto pictures of the video. This information allows, for example, to modify a reference picture associated with a first projection of the scene onto same, so that a synthesized reference picture associated with a second projection is generated. Optionally, the second projection may be similar or equal to a projection of the scene onto a current picture. This, would most probably increase an accuracy and efficiency at inter prediction, since the synthesized reference picture may depict the scene most likely in almost the same way as the current picture.

Accordingly, in accordance with a third aspect of the present application, a video decoder/encoder for decoding/encoding a video of a scene from/into a data stream using motion-compensated prediction, is configured to construct a synthesized reference picture, synthesized so as to form a synthesized version of a predetermined picture, by finding in a (e.g. previously decoded/encoded) reference picture corresponding positions, corresponding to pixels in the predetermined picture, using video-geometry-related parameters, e.g., video-capturing-related parameters, describing how the scene is projected onto pictures of the video, and sampling the reference picture at the corresponding positions. Additionally, the video decoder/encoder is configured to derive, for a current portion of a current picture, a portion inner by sampling a corresponding portion of the synthesized reference picture and reconstruct/encode the current portion using the portion inner.

### BRIEF DESCRIPTION OF THE DRAWINGS

Embodiments of the present invention will be detailed subsequently referring to the appended drawings, in which:

FIG. 1 shows an apparatus for block-wise encoding a picture into a datastream;

FIG. 2 shows a possible implementation of an encoder;

FIG. 3 shows an apparatus for block-wise decoding a picture from a datastream;

FIG. 4 shows a possible implementation of a decoder;

FIG. 5 shows an embodiment of a decoder using temporal sample prediction;

FIG. 6 shows an embodiment illustrating schematically extrinsic and intrinsic camera parameters as video-geometry-related parameters;

FIG. 7 shows an embodiment illustrating a homomorphic mapping defined by video-geometry-related parameters;

FIG. 8 shows an embodiment of a geometric motion vector derivation using four pictures;

FIG. 9 shows an embodiment of a decoder using geometric motion vector prediction;

FIG. 10a shows an embodiment of an encoder encoding video-geometry-related parameters into a data;

FIG. 10b shows an embodiment of an encoder decoding video-geometry-related parameters from a data;

FIG. 11 shows an embodiment for spatial motion vector prediction;

FIG. 12 shows a first embodiment for geometric motion vector prediction considering roll of a camera;

FIG. 13 shows a second embodiment for geometric motion vector prediction considering roll of a camera;

FIG. 14 shows a third embodiment for geometric motion vector prediction considering roll of a camera;

FIG. 15 shows an embodiment of a scene model;

FIG. 16 shows an embodiment of a mesh-based scene model;

FIG. 17 shows an embodiment of a point-cloud-based scene model; and

FIG. 18 shows an embodiment of a decoder using a synthesized reference picture.

### DETAILED DESCRIPTION OF THE INVENTION

Equal or equivalent elements or elements with equal or equivalent functionality are denoted in the following description by equal or equivalent reference numerals or are identified with the same name, and a repeated description of elements provided with the same reference number or being identified with the same name is typically omitted, even if occurring in different figures. Hence, descriptions provided for elements having the same or similar reference numbers or being identified with the same names are mutually exchangeable or may be applied to one another in the different embodiments.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

In the following, a motion vector (MV) is a two dimensional vector that additionally has two different associated pictures, a source- and a destination-picture. The destination picture is the picture whose samples are to be predicted and the source picture is the picture whose samples are the input to this prediction.

An MV that is to be predicted by motion vector prediction is called the target-MV. MVs that are used as inputs by the motion vector prediction process are called input-MVs. An MV that is used to predict the target-MV by calculating a motion vector difference (MVD) is called motion vector predictor (MVP).

For the purpose of video compression, it may be beneficial to use information like the position, orientation and internal properties of the camera recording the video. Parameters like this capture information about where and how objects of the recorded scene appear in the individual video frames. These parameters, e.g., comprised by the herein mentioned video-geometry-related parameters, can be represented as follows: The camera position can be represented by a three dimensional position vector. The orientation of the camera can be represented by three Euler-angles or it can be represented by a four-dimensional rotation-quaternion. The orientation of the camera can also be represented by a normalized direction vector that starts at the position of the camera and points into the viewing-direction of the camera, together with an angle for the rotation around this direction vector.

In addition to these so called extrinsic camera parameters, there are also parameters intrinsic to the camera, for example a focal length, possibly various distortion parameters and the size of the image produced by the camera, which is equal to the amount of samples in the image in the vertical and horizontal image dimensions.

The projection center of a camera is equal to its position. The image plane of a camera is orthogonal to the viewing direction of the camera and the focal length is equal to the distance of the image plane to the projection center.

A pinhole camera is a camera that has no distortion parameters.

For a pinhole-camera, scene-points can be projected to image points on the image plane by taking the line between the scene-point and the projection center and calculating its intersection with the image plane.

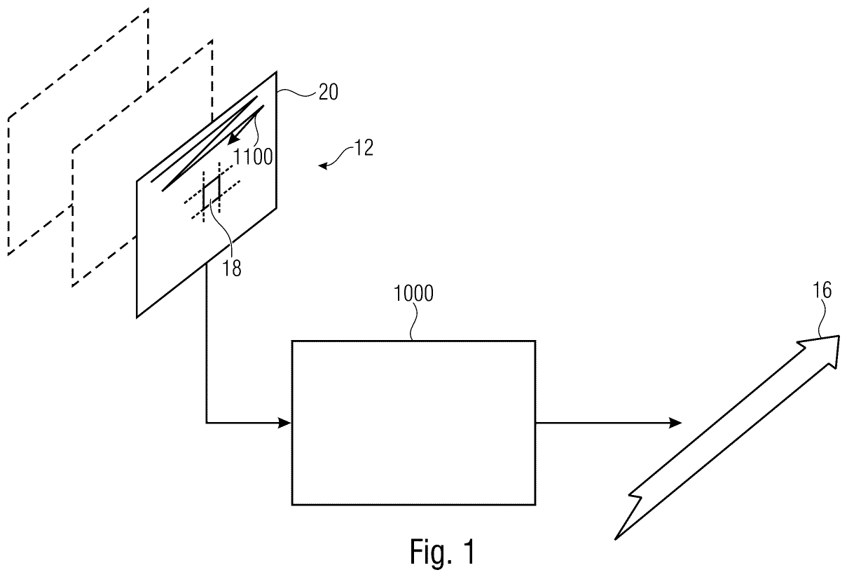

In order to ease the understanding of the following examples of the present application, the description starts with a presentation of possible encoders and decoders fitting thereto into which the subsequently outlined examples of the present application could be built. FIG. 1 shows an apparatus for block-wise encoding a picture 20 into a datastream 16. The apparatus is indicated using reference sign 1000 and may be a still picture encoder or a video encoder. In other words, picture 20 may be a current picture out of a video 12 when the encoder 1000 is configured to encode video 12 including picture 20 into datastream 16, or encoder 1000 may encode picture 20 into datastream 16 exclusively.

As mentioned, encoder 1000 performs the encoding in a block-wise manner or block-base. To this, encoder 1000 subdivides picture 20 into blocks, units of which encoder 1000 encodes picture 20 into datastream 16. Examples of possible subdivisions of picture 20 into blocks 18 are set out in more detail below. Generally, the subdivision may end-up into blocks 18 of constant size such as an array of blocks arranged in rows and columns or into blocks 18 of different block sizes such as by use of a hierarchical multi-tree subdivisioning with starting the multi-tree subdivisioning from the whole picture area of picture 20 or from a pre-partitioning of picture 20 into an array of tree blocks wherein these examples shall not be treated as excluding other possible ways of subdivisioning picture 20 into blocks 18.

Further, encoder 1000 is a predictive encoder configured to predictively encode picture 20 into datastream 16. For a certain block 18 this means that encoder 1000 determines a prediction signal for block 18 and encodes the prediction residual, i.e. the prediction error at which the prediction signal deviates from the actual picture content within block 18, into datastream 16.

Encoder 1000 may support different prediction modes, e.g., the prediction modes described above, so as to derive the prediction signal for a certain block 18. The prediction modes, which are of importance in the following examples, are inter-prediction modes according to which block 18, for example, is predicted from one or more reference pictures by determining a motion vector and copying the prediction signal for this block from a location in the reference picture pointed to by the motion vector. Other optionally supported prediction modes may relate to intra-prediction modes according to which the inner of block 18 is predicted spatially from neighboring, already encoded samples of picture 20. The encoding of picture 20 into datastream 16 and, accordingly, the corresponding decoding procedure, may be based on a certain coding order 1100 defined among blocks 18. For instance, the coding order 1100 may traverse blocks 18 in a raster scan order such as row-wise from top to bottom with traversing each row from left to right, for instance. In case of hierarchical multi-tree based subdivisioning, raster scan ordering may be applied within each hierarchy level, wherein a depth-first traversal order may be applied, i.e. leaf nodes within a block of a certain hierarchy level may precede blocks of the same hierarchy level having the same parent block according to coding order 1100. Depending on the coding order 1100, neighboring, already encoded samples of a block 18 may be located usually at one or more sides of block 18. In case of the examples presented herein, for instance, neighboring, already encoded samples of a block 18 are located to the top of, and to the left of block 18.

In case of encoder 1000 being a video encoder, for instance, encoder 1000 may support inter-prediction modes according to which a block 18 is temporarily predicted from a previously encoded picture of video 12. Such an inter-prediction mode may be a motion-compensated prediction mode according to which a motion vector is signaled for such a block 18 indicating a relative spatial offset of the portion from which the prediction signal of block 18 is to be derived as a copy. Additionally or alternatively, other non-intra-prediction modes may be available as well such as inter-prediction modes in case of encoder 1000 being a multi-view encoder, or non-predictive modes according to which the inner of block 18 is coded as is, i.e. without any prediction.

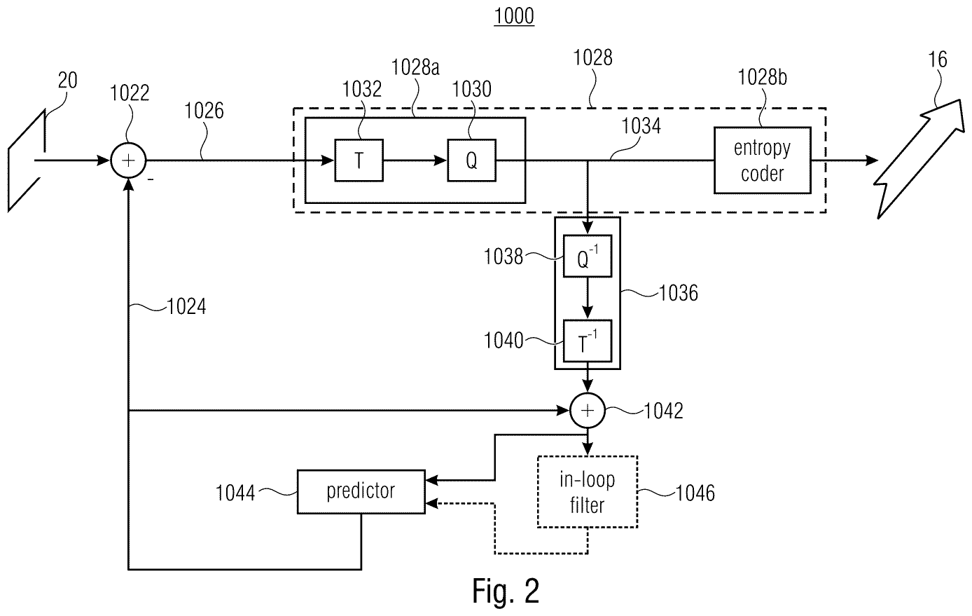

Before starting with focusing the description of the present application onto inter-prediction modes, a more specific example for a possible block-based encoder, i.e. for a possible implementation of encoder 1000, as described with respect to FIG. 2 with then presenting two corresponding examples for a decoder fitting to FIGS. 1 and 2, respectively.

FIG. 2 shows a possible implementation of encoder 1000 of FIG. 1, namely one where the encoder is configured to use transform coding for encoding the prediction residual although this is nearly an example and the present application is not restricted to that sort of prediction residual coding. According to FIG. 2, encoder 1000 comprises a subtractor 1022 configured to subtract from the inbound signal, i.e. picture 20 or, on a block basis, current block 18, the corresponding prediction signal 1024 so as to obtain the prediction residual signal 1026 which is then encoded by a prediction residual encoder 1028 into a datastream 16. The prediction residual encoder 1028 is composed of a lossy encoding stage 1028a and a lossless encoding stage 1028b. The lossy stage 1028a receives the prediction residual signal 1026 and comprises a quantizer 1030 which quantizes the samples of the prediction residual signal 1026. As already mentioned above, the present example uses transform coding of the prediction residual signal 1026 and accordingly, the lossy encoding stage 1028a comprises a transform stage 1032 connected between subtractor 1022 and quantizer 1030 so as to transform such a spectrally decomposed prediction residual 1026 with a quantization of quantizer 1030 taking place on the transformed coefficients where presenting the residual signal 1026. The transform may be a DCT, DST, FFT, Hadamard transform or the like. The transformed and quantized prediction residual signal 1034 is then subject to lossless coding by the lossless encoding stage 1028b which is an entropy coder entropy coding quantized prediction residual signal 1034 into datastream 16. Encoder 1000 further comprises the prediction residual signal reconstruction stage 1036 connected to the output of quantizer 1030 so as to reconstruct from the transformed and quantized prediction residual signal 1034 the prediction residual signal in a manner also available at the decoder (see 1034′), i.e. taking the coding loss is quantizer 1030 into account. To this end, the prediction residual reconstruction stage 1036 comprises a dequantizer 1038 which perform the inverse of the quantization of quantizer 1030, followed by an inverse transformer 1040 which performs the inverse transformation relative to the transformation performed by transformer 1032 such as the inverse of the spectral decomposition such as the inverse to any of the above-mentioned specific transformation examples. Encoder 1000 comprises an adder 1042 which adds the reconstructed prediction residual signal as output by inverse transformer 1040 and the prediction signal 1024 so as to output a reconstructed signal, i.e. reconstructed samples. This output is fed into a predictor 1044 of encoder 1000 which then determines the prediction signal 1024 based thereon. It is predictor 1044 which supports all the prediction modes already discussed above with respect to FIG. 1 and which will be discussed in the following. FIG. 2 also illustrates that in case of encoder 1000 being a video encoder, encoder 1000 may also comprise an in-loop filter 1046 with filters completely reconstructed pictures which, after having been filtered, form reference pictures for predictor 1044 with respect to inter-predicted block.

As already mentioned above, encoder 1000 operates block-based. For the subsequent description, the block bases of interest is the one subdividing picture 20 into blocks for which the inter-prediction mode is selected out of a set or plurality of inter-prediction modes supported by predictor 1044 or encoder 1000, respectively, and the selected inter-prediction mode performed individually. Other sorts of blocks into which picture 20 is subdivided may, however, exist as well. For instance, the above-mentioned decision whether picture 20 is inter-coded or intra-coded may be done at a granularity or in units of blocks deviating from blocks 18. For instance, the inter/intra mode decision may be performed at a level of coding blocks into which picture 20 is subdivided, and each coding block is subdivided into prediction blocks. Prediction blocks with encoding blocks for which it has been decided that inter-prediction is used, are each subdivided to an inter-prediction mode decision. To this, for each of these prediction blocks, it is decided as to which supported inter-prediction mode should be used for the respective prediction block. These prediction blocks will form blocks 18 which are of interest here. Inter-predicted blocks are, for example, predicted from reference pictures by determining a motion vector and copying the prediction signal for this block from a location in the reference picture pointed to by the motion vector. Prediction blocks within coding blocks associated with intra-prediction would be treated differently by predictor 1044. Another block subdivisioning pertains the subdivisioning into transform blocks at units of which the transformations by transformer 1032 and inverse transformer 1040 are performed. Transformed blocks may, for instance, be the result of further subdivisioning coding blocks. Naturally, the examples set out herein should not be treated as being limiting and other examples exist as well. For the sake of completeness only, it is noted that the subdivisioning into coding blocks may, for instance, use multi-tree subdivisioning, and prediction blocks and/or transform blocks may be obtained by further subdividing coding blocks using multi-tree subdivisioning, as well.

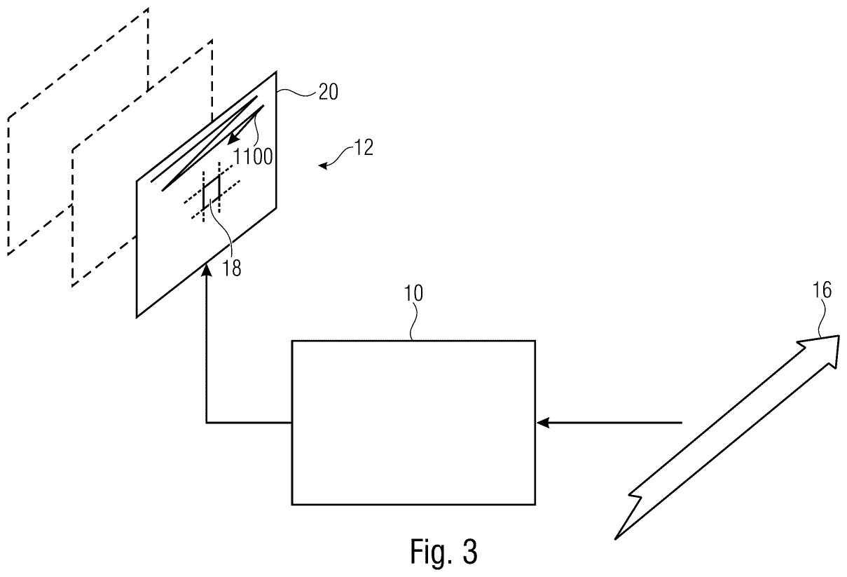

A decoder 10 or apparatus for block-wise decoding fitting to the encoder 1000 of FIG. 1 is depicted in FIG. 3. This decoder 10 does the opposite of encoder 1000, i.e. it decodes from datastream 16 picture 20 in a block-wise manner and supports, to this end, a plurality of inter-prediction modes. The decoder 10 may comprise a residual provider 156, for example. All the other possibilities discussed above with respect to FIG. 1 are valid for the decoder 10, too. To this, decoder 10 may be a still picture decoder or a video decoder and all the prediction modes and prediction possibilities are supported by decoder 10 as well. The difference between encoder 1000 and decoder 10 lies, primarily, in the fact that encoder 1000 chooses or selects coding decisions according to some optimization such as, for instance, in order to minimize some cost function which may depend on coding rate and/or coding distortion. One of these coding options or coding parameters may involve a selection of the inter-prediction mode to be used for a current block 18 among available or supported inter-prediction modes. The selected inter-prediction mode may then be signaled by encoder 1000 for current block 18 within datastream 16 with decoder 10 redoing the selection using this signalization in datastream 16 for block 18. Likewise, the subdivisioning of picture 20 into blocks 18 may be subject to optimization within encoder 1000 and corresponding subdivision information may be conveyed within datastream 16 with decoder 10 recovering the subdivision of picture 20 into blocks 18 on the basis of the subdivision information. Summarizing the above, decoder 10 may be a predictive decoder operating on a block-basis and besides inter-prediction modes, decoder 10 may support other prediction modes such as intra-prediction modes according to which the inner of block 18 is predicted spatially from neighboring, already encoded samples of picture 20. In decoding, decoder 10 may also use the coding order 1100 discussed with respect to FIG. 1 and as this coding order 1100 is obeyed both at encoder 1000 and decoder 10, the same neighboring samples are available for intra-predicted blocks both at encoder 1000 and decoder 10. Accordingly, in order to avoid unnecessary repetition, the description of the mode of operation of encoder 1000 shall also apply to decoder 10 as far the subdivision of picture 20 into blocks is concerned, for instance, as far as prediction is concerned and as far as the coding of the prediction residual is concerned. Differences lie in the fact that encoder 1000 chooses, by optimization, some coding options or coding parameters and signals within, or inserts into, datastream 16 the coding parameters which are then derived from the datastream 16 by decoder 10 so as to redo the prediction, subdivision and so forth.

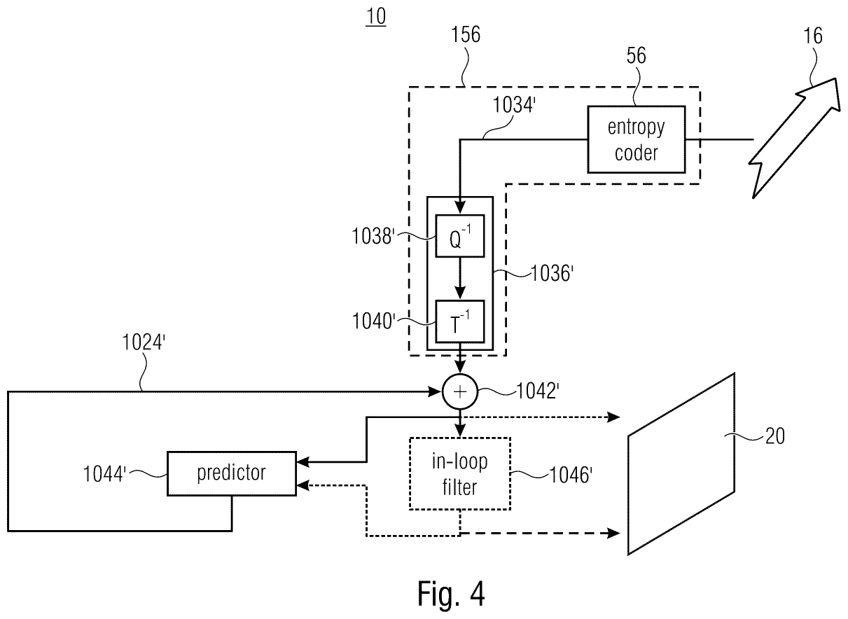

FIG. 4 shows a possible implementation of the decoder 10 of FIG. 3, namely one fitting to the implementation of encoder 1000 of FIG. 1 as shown in FIG. 2. As many elements of the encoder 10 of FIG. 4 are the same as those occurring in the corresponding encoder of FIG. 2, the same reference signs, provided with an apostrophe, are used in FIG. 4 in order to indicate these elements. In particular, adder 1042′, optional in-loop filter 1046′ and predictor 1044′ (e.g., outputting a prediction signal 1024′) are connected into a prediction loop in the same manner that they are in encoder of FIG. 2. The reconstructed, i.e. dequantized and retransformed prediction residual signal applied to adder 1042′ is derived by a sequence of entropy decoder 56 which inverses the entropy encoding of entropy encoder 1028b, followed by the residual signal reconstruction stage 1036′ which is composed of dequantizer 1038′ and inverse transformer 1040′ just as it is the case on encoding side. The decoder's output is the reconstruction of picture 20. The reconstruction of picture 20 may be available directly at the output of adder 1042′ or, alternatively, at the output of in-loop filter 1046′. Some post-filter may be arranged at the decoder's output in order to subject the reconstruction of picture 20 to some post-filtering in order to improve the picture quality, but this option is not depicted in FIG. 4.

Again, with respect to FIG. 4 the description brought forward above with respect to FIG. 2 shall be valid for FIG. 4 as well with the exception that merely the encoder performs the optimization tasks and the associated decisions with respect to coding options. However, all the description with respect to block-subdivisioning, prediction, dequantization and retransforming is also valid for the decoder 10 of FIG. 4.

The embodiments in the following will mostly illustrate the features and functionalities in view of a decoder. However, it is clear that the same or similar features and functionalities can be comprised by an encoder, e.g., a decoding performed by a decoder can correspond to an encoding by the encoder. Furthermore, the encoder might comprise the same features as described with regard to the decoder in a feedback loop, e.g., in the prediction stage 36.

The newly proposed method, for example, uses picture motion parameters, e.g., comprised by the video-geometry-related parameters, that summarily describe the motion between entire pictures to perform motion vector prediction or to perform temporal sample prediction.

### 1 Temporal Sample Prediction (Motion Compensated Sample Prediction)

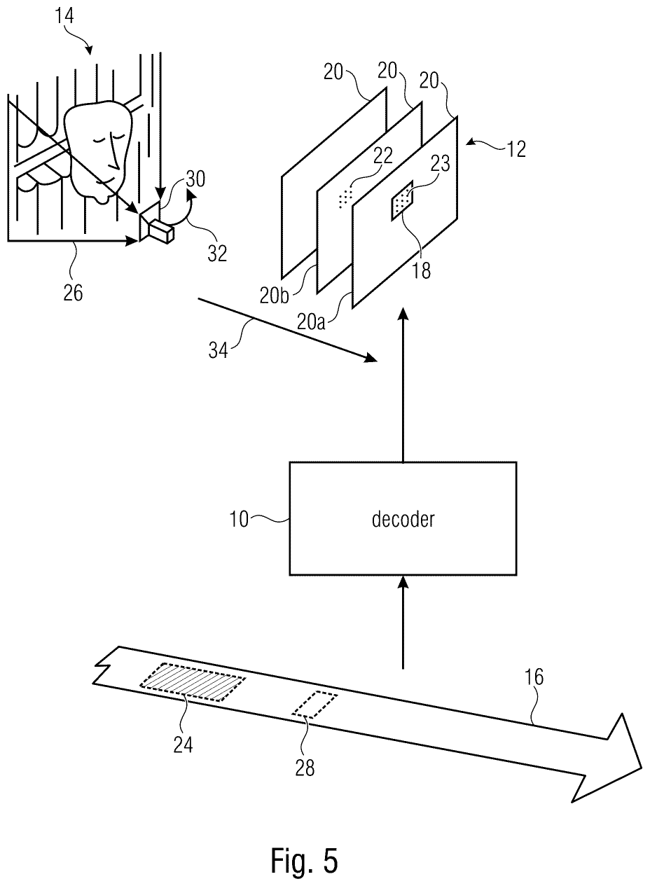

FIG. 5 shows exemplarily a Video decoder 10 for decoding a video 12 of a scene 14 from a data stream 16 using motion-compensated prediction, configured to
derive, for a current block 18 of a current picture 20a, a predicted block inner by finding in a (e.g. previously decoded; but not necessarily the immediately preceding one in terms of presentation time order 34 (rather, the reference picture might even be temporally farther away from picture 20a and may even follow picture 20a in terms of order 34)) reference picture 20b corresponding positions 22, corresponding to pixels 23 in the current block 18, using video-geometry-related parameters 24 (or, using a different term: video-capturing-related parameters; irrespective of the term used, and with this also being valid for the whole application and the claims with capital letters, the parameters shall also include the case that the video is synthetically generated by means of, for example, an artificial intelligence, a neural network or using 3D rendering rather than being captured by a camera 30 as depicted in the figure as possibly moving 32 so that disparity results between pairs of pictures such as pictures 20a and 20b) describing how the scene 14 is projected 26 onto pictures 20 of the video 12, and sampling the reference picture 20b at the corresponding positions 22 (a further note: the finding might involve no MV or might involve a MV sent for the current block in the data stream, such as in order to pre-offset the current block's pixels first before finding the corresponding pixels relative to these pre-offset pixels' positions), and
reconstruct the current block 18 using the predicted block inner (e.g. by means of adding to the predicted block inner a prediction residual 28 decoded from the data stream).

A corresponding video encoder for encoding a video 12 of a scene 14 into a data stream 16 using motion-compensated prediction may be configured to derive, for a current block 18 of a current picture 20a, a predicted block inner by finding corresponding positions 22 in a (e.g. previously encoded) reference picture 20b, corresponding to pixels 23 in the current block 18, using video-geometry-related parameters 24 describing how the scene 14 is projected 26 onto pictures 20 of the video 12, and sampling the reference picture 20b at the corresponding positions 22, and configured to encode the current block 18 using the predicted block inner.

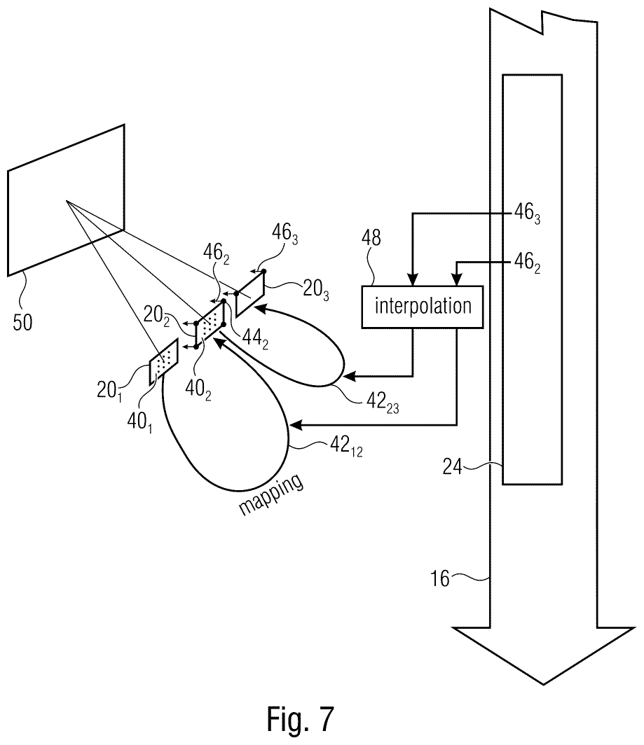

The finding of the corresponding positions in the reference picture might involve
e.g., for each pixel 23 in the current block 18, projecting the respective pixel 23 onto a respective scene point in the scene 14 using the video-geometry-related parameters (e.g., by deriving from the video-geometry-related parameters a first scene projection line along which the respective scene point is projected onto the respective pixel together with a distance, e.g., a scene depth, of the respective scene point from the current picture 20a and by determining the respective scene point to be on the first scene projection line at the distance) and projecting the respective scene point onto the respective corresponding position 22 in the reference picture 20b using the video-geometry-related parameters (e.g., by deriving from the video-geometry-related parameters a second scene projection line along which the respective scene point is projected onto the reference picture and by determining the intersection of the second scene projection line with the reference picture 20b as the respective corresponding position 22), or
e.g., deriving for the pixels 23 in the current picture from a homomorphic mapping (e.g., as described with regard to FIG. 7) between the current picture and the reference picture 20b the corresponding positions 22 in the reference picture 20b, wherein the homomorphic mapping is defined by the video-geometry-related parameters (e.g., for the current picture 20a and not for individually blocks; the homomorphic mapping describes, for example, a mapping of two or more corners of the current picture onto corresponding positions in the reference picture and the homomorphic mapping for the pixels 23 in the current picture and their corresponding positions in the reference picture may be determined by interpolation).

The video-geometry-related parameters 24 may describe a scene-to-picture projection 26 of one camera 30 projecting the scene 14 onto the pictures 20 of the video, e.g., for each picture 20 of the video 12, e.g., picture-wise and picture globally. The scene-to-picture projection 26 for a certain picture 20 may be described by parameters defining scene projection lines along which scene points of the scene 14 are projected onto respective pixels within the certain picture 20 together with parameters defining distances between the scene points and the certain picture 20. Alternatively, the scene-to-picture projection 26 for a certain picture 20 may be described by a homomorphic mapping (e.g., as described with regard to FIG. 7) between a certain picture and a reference picture.

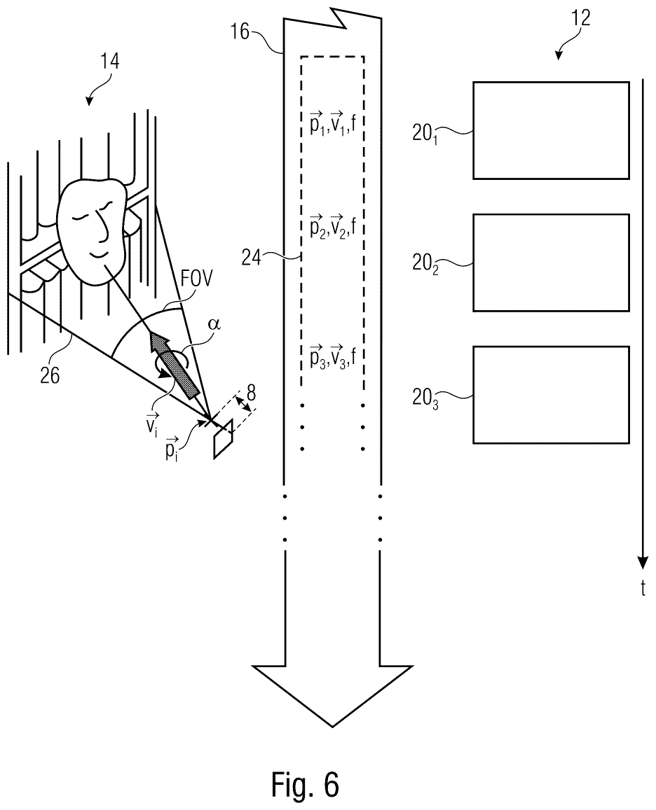

As depicted in FIG. 6, the video-geometry-related parameters 24 may describe the scene-to-picture projection 26 by means of one or more of one or more extrinsic camera parameters (e.g., defining a position of the camera in space (translation vector; \vec{p}ᵢ) and/or an orientation of the camera in space (the orientation is, e.g., defined by a combination of pitch, yaw, and roll; e.g., represented by three Euler-angles; or represented by a four-dimensional rotation-quaternion (e.g., a normalized direction vector \vec{v}ᵢ that starts at the position of the camera and points into the viewing-direction of the camera, together with an angle α for the rotation around this direction vector \vec{v}ᵢ.))) and/or one or more intrinsic camera parameters (e.g. focal length f and/or FOV angle) of the one camera. The one or more extrinsic camera parameters and the one or more intrinsic camera parameters may be parameters of a real camera or of a virtual camera (e.g., for a synthetically generated video).

FIG. 6 shows exemplarily a data stream 16 comprising the video-geometry-related parameters 24 picture-wise and picture globally, e.g., the video-geometry-related parameters 24 may comprise extrinsic camera parameters \vec{p}₁, \vec{v}ᵢ and the intrinsic camera parameter f for a first picture 20₁ of a video 12, extrinsic camera parameters \vec{p}₂, \vec{v}₂ and the intrinsic camera parameter f for a second picture 20₂ of the video 12 and extrinsic camera parameters \vec{p}₃, \vec{v}₃ and the intrinsic camera parameter f for a third picture 20₃ of the video 12. The first picture 20₁ may correspond to the current picture 20a in FIG. 5 and the second picture 20₂ may correspond to the reference picture 20b in FIG. 5.

As shown in FIG. 7, additionally, or alternatively, the video-geometry-related parameters may describe a homomorphic mapping, e.g., see 42₁₂, between corresponding positions 40₁ 40₂ in pairs of pictures 20₁, 20₂ of the video, i.e. between first positions 40₁ in a first picture 20₁ and second positions 40₂ in a second picture 20₂, or a homomorphic mapping between corresponding motion vectors relating to pairs of pictures of the video (e.g. the corresponding motion vectors might relate to a predefined temporal frame distance). The homomorphic mapping 42 may represent a structure-preserving mapping.

The video-geometry-related parameters may describe the homomorphic mapping 42 by means of vectors 46₂ or tensors at predetermined control points 44₂ of the video's pictures (e.g. along with a predefined interpolation 48 being defined between the control points 44₂). In other words, the video-geometry-related parameters 24 are a set of control-point motion vectors, see vectors 46₂, describing an MV-field between two pictures. The predetermined control points may be corners of the video's pictures. The video-geometry-related parameters may comprise, per picture, merely one vector 46₂ or tensor for each of the four corners of the video's pictures (e.g. along with a predefined interpolation 48 being defined between the control points 44₂).

According to an embodiment, the video decoder 10 (and the corresponding video encoder) is configured to derive, for a predetermined picture, e.g., for the current picture 20a, a scene-to-picture projection 26 projecting the scene 14 onto the predetermined picture based on a sequence of the homomorphic mapping, e.g., 42₁₂ and 42₂₃, between corresponding positions 40 in one or more pairs of pictures including the predetermined picture and a base picture and based on extrinsic and intrinsic parameters, e.g., \vec{p}_{b}, \vec{v}_{b} and f, for the base picture.

As shown in FIG. 7 the position and the orientation of the frames 20 can be signaled with a set of motion vectors 46 at specific control points 44. Where the motion vectors 46 describe the displacement at the control points, e.g., 44₂, of the current picture, e.g. 20₂, relative to a reference picture, e.g. 40₁. That is, according to this option, the video-geometry-related parameters 24 contain, for a picture 20, one vector 46 per corner, i.e. per control point 44, of that picture 20, and these vectors 46 describe the offset of the corners' positions from their corresponding positions in some “reference picture”. The latter picture may be the immediately preceding picture—in terms of coding or presentation time order- or may be another picture. The pictures form, thus, a pair (a,b) with a being, for instance, the POC of the picture 20 for which the vectors 46 are transmitted in the data stream 16 as part of the video-geometry-related parameters 24, and b is the associated “reference” picture. For instance, such pairs may be defined to follow the GOP structure interdependencies between the pictures of a GOP. For sake of achieving knowledge on the effective vectors 46 for the corners of a certain picture a with respect to a predetermined reference picture x, decoder and encoder may simply concatenate (add) the video-geometry-related parameters' vectors 46 for the corners for picture pairs (a,b), (b,c), (c, . . . ) . . . ( . . . ,x) with selecting, for instance, the smallest such sequence of picture pairs for which there are vectors 46 in the video-geometry-related parameters 24. When for the current picture a and the reference picture b for the current block, the video-geometry-related parameters 24 contain the corners' vectors for pair (a,b), no such concatenation is necessary.

The vector mapping or homomorphismus is, for example, realized by using the effective vectors 46 as supporting vectors for some interpolation 48 to yield the mapped vectors for certain positions 40 to be mapped to. For instance, the homomorphism realized by the corners' vectors for pair picture (a,b) may represent a mapping 42 which maps picture points in picture a onto corresponding points in picture b with, for instance, assuming that mutually corresponding points in these pictures a and b lie, in the scene, in a scene plane 50. This scene plane 50 may, for instance, be a background plane of the captured scene 14 such as a wall or the like, e.g. the book shelf behind the head in the foreground illustrated in scene 14 in FIG. 5 and FIG. 6.

When additionally camera intrinsic parameters are given, it is also possible to derive from the homomorphism (possibly multiple) solutions for extrinsic camera parameters and parameters defining this scene plane 50. Projection of any point in the scene plane 50 into that camera and into a camera at the origin defines the same mapping between the resulting image points as does the homomorphism. Multiple solutions may result from the derivation of extrinsic camera parameters from the homomorphism, i.e. the vectors 46 at the picture corners, but a predetermined rule may be used to select one of these solutions both at decoder and encoder.

This might seem to collide with the view that the homomorphism is only defined between two pictures 20 whereas camera parameters seem to stand for one picture 20 and independently of other pictures 20. But this is just a question of the point of reference, i.e. we can choose any coordinate system for the (camera-) parameters: for example we can put the parameters of the first picture (of some group) at the origin and this means that all camera parameters are now relative to that picture. The same is true for homomorphism parameters. It would actually be bad to use an origin that is not equivalent to one useful set of parameters, as in effect we would waste description length (or bits) to have this useless origin. Put differently, the entropy coding will calculate differences and thus derive relative parameters anyway.

The control point vectors 46 may be seen, thus, as an alternative representation of the camera parameters defining the camera position and orientation. This alternative representation is possibly better adapted to entropy coding which might be used for coding parameters 24 into stream 16. The coding might include a quantizing of the parameters and the quantization errors of control point vectors 46 proportionally cause errors in the image plane. Quantization errors of rotation angels or depth-related camera position errors are more difficult to control with respect to their consequences. Nevertheless it is also possible that the video-geometry-related parameters 24 provide for a picture 20 of the video 12 a combination of extrinsic and/or intrinsic camera parameters and parameters, e.g., the vectors 46, defining a homomorphic mapping.

With respect to the discrepancy between the homomorphism-defining corner vectors which are defined between picture pairs on the one hand and the camera projection parameters such as the extrinsic ones which are defined for each picture individually, the following shall be noted: it is correct that the homomorphism is only defined between two pictures whereas camera parameters seem to stand for one picture and independently of other pictures. But this is just a question of the point of reference. We can choose any coordinate system for the (camera-) parameters: for example we can put the parameters of the first picture (or some group of pictures) at the origin and this means that all camera parameters are now relative to that picture. The same is true for homomorphism parameters. It would actually be bad to use an origin that is not equivalent to one useful set of parameters, as in effect we would waste description length (or bits) to have this useless origin. Put differently, the entropy coding will calculate differences and thus derive relative parameters anyway.

As can be seen in FIGS. 5 to 7, the video decoder 10 is configured to decode the video-geometry-related parameters 24 from the data stream 16 and a video encoder may be configured to encode the video-geometry-related parameters 24 into the data stream 16. The video decoder 10 may be configured to determine the video-geometry-related parameters 24 based on an already decoded portion of the video 12 and the video encoder may be configured to determine the video-geometry-related parameters 24 based on an already encoded portion of the video 12.

The video decoder 10 described with regard to FIG. 5 to FIG. 7 may be configured to decode a syntax element from the data stream 16 (e.g. at block level, such as an MVP candidate list index, or a mode syntax element, or at higher level, tuning the motion-compensation prediction tool), and if the syntax element has a first state,
derive, for the current block 18, the predicted block inner by finding in the reference picture 20b corresponding positions 22, corresponding to pixels 23 in the current block 18, using video-geometry-related parameters 24 describing how the scene 14 is projected onto pictures 20 of the video 12, and sampling the reference picture 20b at the corresponding positions 22, and
reconstruct the current block 18 using the predicted block inner.

A corresponding video encoder may be configured to encode the syntax element into the data stream 16 and derive, for the current block 18, the predicted block inner as described for the decoder and encode the current block 18 using the predicted block inner.

Optionally, if the syntax element has a second state, the video decoder 10 may be configured to reconstruct the current block 18 independent from the video-geometry-related parameters 24, or reconstruct the current block 18 by copying an already decoded video portion at a regular inter-pixel pitch (e.g. no warping). Similarly a corresponding video encoder may in this case be configured to encode the current block 18 independent from the video-geometry-related parameters 24, or encode the current block 18 by copying an already encoded video portion at a regular inter-pixel pitch (e.g. no warping).

According to an embodiment, the video decoder 10 is configured to derive a list of MVP candidates for the current block 18, one of the MVP candidates corresponding to a specific motion-vector-less inter-coding mode, select a selected MVP out of the list of MVP candidates, and reconstruct the current block 18 using the selected MVP by
if the selected MVP corresponds to the specific motion-vector-less inter-coding mode,
   deriving, for the current block 18, the predicted block inner by finding corresponding positions 22 in the (e.g. previously decoded) reference picture 20b, corresponding to pixels 23 in the current block 18, using video-geometry-related parameters 24 describing how the scene 14 is projected onto pictures 20 of the video 12, and sampling the reference picture 20b at the corresponding positions 22, and
   reconstructing the current block 18 using the predicted block inner,
if the selected MVP corresponds to a MVP candidate other than the specific motion-vector-less inter-coding mode,
   reconstructing the current block 18 using motion-vector-compensated prediction using the selected MVP.

Similarly a video encoder may be configured to derive a list of MVP candidates for the current block 18, one of the MVP candidates corresponding to a specific motion-vector-less inter-coding mode, select a selected MVP out of the list of MVP candidates, and encode the current block 18 using the selected MVP by
if the selected MVP corresponds to the specific motion-vector-less inter-coding mode,
   deriving, for the current block 18, the predicted block inner by finding corresponding positions 22 in the (e.g. previously decoded (e.g., stored in the decoding buffer) or encoded) reference picture 20b, corresponding to pixels 23 in the current block 18, using video-geometry-related parameters 24 describing how the scene 14 is projected onto pictures 20 of the video 12, and sampling the reference picture 20b at the corresponding positions 22, and
   encoding the current block 18 using the predicted block inner,
if the selected MVP corresponds to a MVP candidate other than the specific motion-vector-less inter-coding mode,
   encoding the current block 18 using motion-vector-compensated prediction using the selected MVP.

For additional embodiments, reference is made to the description below as far as describing the video-geometry-related parameters, for instance.

These parameters can be coded inside the bitstream, i.e. the data stream 16, or they can be derived at the decoder from previously decoded information.

As described above, in one embodiment of the invention, the picture motion parameters, i.e. the video-geometry-related parameters 24, are pinhole camera parameters associated to each picture 20 of the video 12 (e.g., see FIG. 6 and the description with regard to intrinsic and extrinsic camera parameters). In another embodiment, the picture motion parameters are a set of control-point motion vectors associated to each picture describing an MV-field between two pictures (e.g., see FIG. 7 and the description with regard to homomorphic mapping).

### 2 Motion Vector Prediction

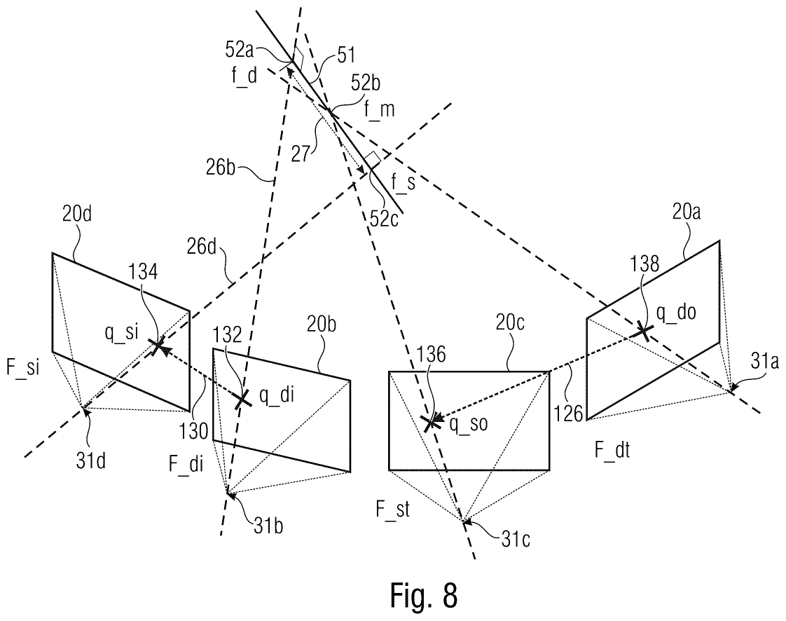

In case the picture motion parameters, i.e. the video-geometry-related parameters 24, are camera parameters, for example, the newly proposed method combines camera parameters with MVs to reconstruct estimated three dimensional scene-points as described in the following with respect to FIG. 8.

FIG. 8 shows an embodiment for a geometric motion vector derivation using four pictures, e.g. a current picture 20a (also denoted as F_{dt}), a source picture 20b (also denoted as F_{di}), a reference picture 20c (also denoted as Fₛₜ) and a further reference picture 20d (also denoted as Fₛᵢ). The source picture 20b, the reference picture 20c and the further reference picture 20d may represent previously decoded/encoded pictures of a video. In some cases, e.g. at spatial motion vector prediction, which will be described below in more detail, the geometric motion vector derivation may be performed using less than four pictures.

As described above, a motion vector (MV) is a two dimensional vector that additionally has two different associated pictures, a source- and a destination-picture. A tail of the motion vector may be placed in the destination picture and a head of the motion vector may point into the source picture. At the herein proposed motion vector derivation a first MVP 130 (also denoted as input motion vector MVᵢ in the following) may be derived. The first MVP 130 may be associated with the source picture 20b (also denoted as F_{di}) and the further reference picture 20d (also denoted as Fₛᵢ), for which reason the source picture 20b may in the following also be denoted as the associated destination picture and the further reference picture 20d may also be denoted as the associated source picture. Herein it is proposed to geometrically determine a predetermined motion vector predictor 126 based on the first MVP 130. The predetermined motion vector predictor 126 may be associated with the current picture 20a (also denoted as F_{dt}) and the reference picture 20c (also denoted as Fₛₜ), for which reason the current picture 20a may in the following also be denoted as the associated destination picture or as an arbitrary destination picture and the reference picture 20c may also be denoted as the associated source picture or as an arbitrary source picture.

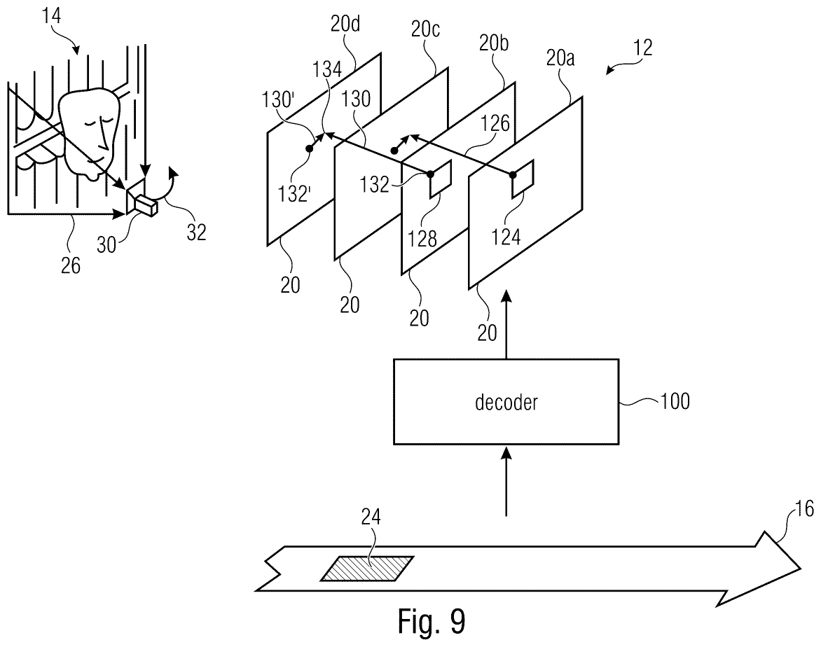

For an input motion vector MVᵢ 130 (with associated source and destination pictures Fₛᵢ, F_{di}), two rays, a source- and a destination-ray may be formed that pass through the projection center 31 of the camera associated to Fₛᵢ/F_{di} and pass through a certain source/destination point in the image plane of the respective camera, e.g., a first scene projection line 26b passing through a first picture position 132 (herein also denoted as q_{di} or destination point) in the source picture 20b and a second scene projection line 26d passing through a second picture position 134 (herein also denoted as qₛᵢ or source point) in the further reference picture 20d. The destination point qui 132 in the image plane, i.e. in the source picture 20b, for translational motion is either the top left corner of the block 128 the MVᵢ 130 is associated to, or is the center of this block 128, or is the bottom right corner of this block 128. The source point qₛᵢ 134 is the sum of the destination point 132 and the input MV 130; qₛᵢ=q_{di}+MVᵢ, e.g., see also FIG. 9. Of a current block 124 in the current picture 20a a corresponding co-located block 128 may be represented by the block 128 in the source picture 20b to which the input motion vector MVᵢ 130 is associated to.

For affine predicted blocks the destination point qui 132 may be one of the control points (top-left and top-right for 4 parameter model, plus bottom left for 6 parameter model, plus bottom right for 8 parameter model) that parameterize the affine model. Each of the required destination points 132 are individually considered for the affine predicted block. The sum of each of the destination points qui 132 and its associated motion vector MVᵢ yields qₛᵢ 134, the source point for each of the control points.

If q_{di} and qₛᵢ are projections of the same three dimensional scene point, the two rays 26b and 26d intersect at the scene point. This is not necessarily the case for an arbitrary MVᵢ 132 (chosen by the encoder control) and estimated camera parameters. To estimate scene points given this uncertainty, the proposed method considers at least three scene point estimates, see 52a (f_{d}), 52b (fₘ) and 52c (fₛ), that are derived using the shortest distance 27 between the two rays 26b and 26d in three dimensional space. The points considered are two points fₛ 52c and fa 52a, one on each ray, that have the shortest distance 27 of any two such points. The third point fₘ 52b is the mid-point between the first two points, i.e. fₘ=(fₛ+f_{d})/2. The distance between fₛ and f_{d} is dₘᵢₙ.

A three dimensional scene point like fₘ (called Q in the following) can also be obtained in different ways e.g. by solving a system of equations or by minimizing a reprojection error at the points q_{di} and qₛᵢ.

For example

1) According to an embodiment, a scene point 52 can be determined by determining a system of linear equations and solving the system of linear equations. The system of linear equations can be determined using the video-geometry-related parameters 24, the first picture position 132 of the reference block 128 and the second picture position 134 of the further reference picture 20d, wherein the first MVP 130 points to the second picture position 134 of the further reference picture 20d by placing a tail of the first MVP 130 onto the first picture position 132.

For example, the scene point 52 can be determined by solving (finding a solution with the lowest error for) the homogeneous linear equation system AQ=0, e.g. by using the singular value decomposition (SVD) method.

Here, Q is the 3d-point to be determined, in homogeneous coordinates, Q= [X Y Z 1].

A is a 3×4 matrix with rows

$$A . row ( 0 ) = {q}_{di} ( 0 ) * {cam}_{di} . row ( 2 ) - {cam}_{di} . row ( 0 )$$

$$A . row ( 1 ) = {q}_{di} ( 1 ) * {cam}_{di} . row ( 2 ) - {cam}_{di} . row ( 1 )$$

$$A . row ( 2 ) = {q}_{si} ( 0 ) * {cam}_{si} . row ( 2 ) - {cam}_{si} . row ( 0 )$$

$$A . row ( 3 ) = {q}_{si} ( 1 ) * {cam}_{si} . row ( 2 ) - {cam}_{si} . row ( 1 ) .$$

where camₓ.row(.) are the rows of the 3×4 camera matrices of the Fₛᵢ and F_{di} associated cameras, each consisting of a horizontally concatenated rotation matrix R and translation vector t, i.e. camₓ=[R|t],
and q_{di} and qₛᵢ are the 2d image-points in image F_{di} and Fₛᵢ, e.g. qₓᵢ(0) denoting image-coordinate x and qₓᵢ(1) denoting image-coordinate y in image 1.

If the singular value decomposition (SVD) of A yield 3 matrices U,S and V satisfying the equation A=USV. The fourth column of V, denoted by V.col(3), determines the solution for Q:
Q=V.col(3)/V.col(3)(3) where Q is used instead of fₘ as intersection point for the reprojections.

2) According to an embodiment, a scene point 52 can be determined by minimizing a cost function depending on re-projection errors. The cost function may be a sum of two squared re-projection errors, a sum of errors to the power of three, a mean squared error, a root mean squared error, a mean absolute error, a mean squared logarithmic error or any other cost function. The re-projection errors may comprise a distance between the first picture position 132 of the reference block 128 in a source picture 20b and a projection of the scene point 52 onto the source picture 20b, and a distance between the second picture position 134 of the further reference picture 20d and a projection of the scene point 52 onto the further reference picture 20d, wherein the first MVP 130 points to the second picture position 134 of the further reference picture 20d by placing a tail of the first MVP 130 onto the first picture position 132.

For example, the scene point 52 can be determined by minimizing the sum of the two squared re-projection errors, i.e. the squared distance in image coordinates between the point qₛᵢ and the projection of a 3d-point Q onto image Fₛᵢ, plus the squared distance in image coordinates between the point f_{di} and the-projection of Q onto image F_{di}. This can be achieved by first calculating from fₛᵢ and f_{di} and the camera parameters, optimal image points fₛᵢ ′ and f_{di}′, e.g. by the algorithm described in P. Lindstrom “Triangulation Made Easy”, or by other means. The rays created by fₛᵢ ′and f_{di}′ will intersect and the 3d point Q is the intersection point.

Accordingly, as shown in FIG. 9, a video decoder 100 for decoding a video 12 of a scene 14 from a data stream 16 using motion-compensated prediction may be configured to derive, for a current block 124, a predetermined motion vector predictor (MVP) 126 using video-geometry-related parameters 24 describing how the scene 14 is projected 26 onto pictures 20 of the video 12, and reconstruct the current block 124 using the predetermined MVP 126. The MVP 126 may describe a spatial offset in the picture plane between a picture position of the current block 124 in the current picture 20a and a corresponding position in the reference picture 20c.

A corresponding video encoder for encoding a video 12 of a scene 14 into a data stream 16 using motion-compensated prediction may be configured to derive, for a current block 124, a predetermined motion vector predictor (MVP) 126 using video-geometry-related parameters 24 describing how the scene 14 is projected 26 onto pictures 20 of the video 12, and encode the current block 124 using the modified MVP 126.

The video decoder may be configured to reconstruct the current block 124 using the predetermined MVP 126 by means of superposition of the predetermined MVP 126 and a motion vector difference (MVD) decoded from the data stream 16 to obtain a final motion vector to fetch prediction samples from the reference picture 20c for the current block 124 and adding to the prediction samples a prediction residual decoded from the data stream 16. The video encoder may be configured to encode the current block 124 using the predetermined MVP 126 by means of determining and encoding a motion vector difference (MVD) between a final motion vector and the predetermined MVP 126 and by encoding a prediction residual into the data stream 16, wherein prediction samples fetched from the reference picture 20c for the current block 124 using the final motion vector combined with the prediction residual may represent the current block 124.

The video decoder 100 may be configured to derive the predetermined motion vector predictor (MVP) 126 by deriving, for the current block 124, a first MVP 130 from a previously decoded portion 128 of the video 12, and modifying the first MVP 130 using the video-geometry-related parameters 24 so as to obtain the predetermined MVP 130, i.e. determining geometrically the predetermined MVP 130 based on the first MVP 130 using the video-geometry-related parameters 24. A corresponding encoder may perform the derivation of the predetermined motion vector predictor 126 similarly with the difference that the first MVP 130 is derived from a previously encoded portion of the video 12. However, it is also possible that the encoder is configured to derive the first MVP 130 from a previously decoded portion of the video 12, e.g. stored in a decoding buffer of the encoder, e.g., in a decoding unit of the video encoder.

In the context of motion vectors, the term “modifying” may encompass determining a new motion vector based on another motion vector. For example, modifying the first MVP 130 so as to obtain the predetermined MVP 126 may mean that the predetermined MVP 126 is determined based on the first MVP 130. The predetermined MVP 126 may replace the first MVP 130, i.e. the predetermined MVP 126 may be used instead of the first MVP 130. As shown exemplarily in FIG. 8, the first MVP 130 may be “modified” by mapping (e.g., using a geometrical mapping defined be the video-geometry-related parameters 24) the first MVP 130 onto the predetermined MVP 126. Thus, the predetermined MVP 126 can be considered as a modified version of the first MVP 130. After “modifying” a motion vector, the modified motion vector may not be associated with the same source and destination pictures as the unmodified motion vector.

As described with regard to FIG. 6 and FIG. 7, the video-geometry-related parameters 24 may describe a scene-to-picture projection 26 of one camera projecting the scene 14 onto the pictures 20 of the video 12, e.g., for each picture of the video, e.g., picture-wise and picture globally. As described with regard to FIG. 6, the video-geometry-related parameters 24 may describe the scene-to-picture projection 26 by means of one or more of one or more extrinsic camera parameters and one or more intrinsic camera parameters (e.g. focal length or FOV angle) of the one camera. As described with regard to FIG. 7, the video-geometry-related parameters 24 may describe a homomorphic mapping 42 between corresponding positions 40 in pairs of pictures 20 of the video 12 or a homomorphic mapping between corresponding motion vectors relating to pairs of pictures of the video (e.g. the corresponding motion vectors might relate to a predefined temporal frame distance).

The homomorphic mapping 42 may be realized by using vectors 46 for the corners of the current picture 20a with respect to the reference picture 20c as supporting vectors for some interpolation 48 to yield mapped vectors for certain positions to be mapped to. For instance, to obtain the predetermined MVP 126 for the current block 124 of the current picture 20a, the interpolation may be used to map a position of the current block 124 onto a corresponding position within the reference picture 20c and use the difference as the predetermined MVP 126.

When camera intrinsic parameters are given, it is also possible to derive from the homomorphism (possibly multiple) solutions for extrinsic camera parameters and parameters defining the scene plane 50. Projection of any point in the scene plane 50 into that camera and into a camera at the origin defines the same mapping between the resulting image points as does the homomorphism. However, the predetermined MVP 126 can be derived using these camera parameters by triangulation exactly like described below. That is, using the homomorphism-parameters, it is possible that encoder and decoder perform the triangulation based tasks described below in order to derive a predetermined MVP. We are not limited to using the homomorphism-parameters only for following the homomorphic mapping between two pictures. We can also use them for triangulation using input-MVs exactly like below.

The video encoder maybe configured to encode the video-geometry-related parameters 24 into the data stream 16 and the video decoder 100 may be configured to decode the video-geometry-related parameters 24 from the data stream 16. The video encoder maybe configured to determine the video-geometry-related parameters 24 based on an already encoded portion of the video 12 and the video decoder 100 may be configured to determine the video-geometry-related parameters 24 based on an already decoded portion of the video 12.

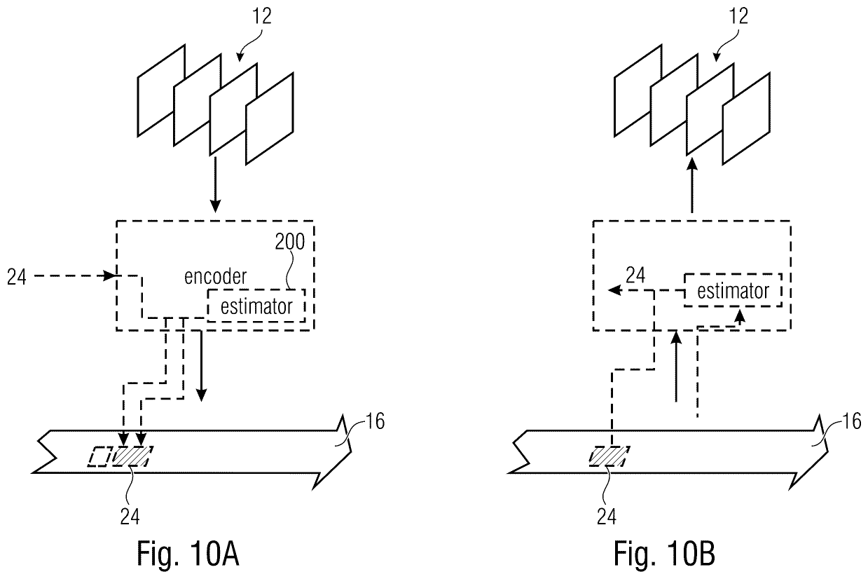

According to an embodiment shown in FIGS. 10a and 10b the video encoder is configured to determine 200 the video-geometry-related parameters 24 based on the video 12 and encode the video-geometry-related parameters 24 into the data stream 16. Alternatively, the video encoder may be configured to determine the video-geometry-related parameters 24 based on a version of the video as resulting from decoding the data stream, e.g., from a decoding buffer of a decoding unit of the video encoder.

The video encoder may be configured to determine the video-geometry-related parameters 24 using one or more of
optimizing the video-geometry-related parameters 24 or a portion thereof, by means of rate-distortion optimization;
using stereo matching; and
background/foreground bisegmentation.

The video decoder 100 described with regard to FIG. 8 and FIG. 9 and the corresponding video encoder may be configured to derive from the video-geometry-related parameters 24, one or more of
a first scene-to-picture projection for the current picture 20a (Fat) which the current block 124 is part of,
a second scene-to-picture projection for the reference picture 20c (Fₛₜ) which the predetermined MVP 126 relates to,
a third scene-to-picture projection for the source picture 20b (F_{di}) from which the first MVP 130 is derived,
a fourth scene-to-picture projection for the further reference picture 20d (Fₛᵢ) which the first MVP 130 relates to.

As will be described below in more detail, the one or more of the first to fourth scene-to-picture projections can be used to geometrically derive the predetermined motion vector predictor 126.

The video decoder 100 and the corresponding video encoder may be configured to modify the first MVP 130 using the video-geometry-related parameters 24 by
determining one or more scene points 52 (e.g. fₘ, f_{d}, fₛ) in the scene using the video-geometry-related parameters 24, a first picture position 132 of a reference block 128, from which the first MVP 130 is derived, and the first MVP 130, and
determining the predetermined MVP 126 using the video-geometry-related parameters 24 and the one or more scene points 52.

For determining the one or more scene points 52, for example, the third scene-to-picture projection and the fourth scene-to-picture projection may be derived from the video-geometry-related parameters 24 and used. For determining the predetermined MVP 126, for example, the first scene-to-picture projection and the second scene-to-picture projection may be derived from the video-geometry-related parameters 24 and used.

The reference block 128 in the source picture 20b may be co-located to the current block 124 in the current picture 20a and the first picture position 132 may correspond to the top left corner of the reference block 128, or to the center of the reference block 128, or to the bottom right corner of the reference block 128.

An embodiment of the newly proposed method derives MVPs as follows.

At a first place, a MVP, i.e. the predetermined MVP 126, for a current block 124 in a current picture 20a may be generated by means of video-geometry-related parameters 24 so that the predetermined MVP 126 describes the spatial offset in the picture plane between a picture position of the current block 124 in the current picture 20a and a corresponding position in the reference picture 20c, e.g., see FIG. 9.

At a second place, video-geometry-related parameters 24 may be used to “improve” otherwise predicted (first) MVPs 130. In other words, any MV (with associated source and destination pictures Fₛᵢ, F_{di}, e.g. the first MVP 130 associated with the source picture 20b (also denoted as F_{di}) and the further reference picture 20d (also denoted as Fₛᵢ)) that can be derived at the decoder 100, can be used as an input-MV MVᵢ for the estimation of scene points 52 as described above. The predetermined MVP 126 for arbitrary source and destination pictures Fₛₜ, F_{dt} (associated to the target-MV) is derived from the scene-point estimates 52 by projecting a scene-point (for example the mid-point fₘ 52b) onto the image planes of the cameras associated to Fₛₜ, Fdt, thus obtaining projected output points qₛₒ, e.g., referenced by 136, and q_{do}, e.g., referenced by 138, in two dimensional image space. The term “arbitrary” means that the described geometrical derivation of the predetermined MVP 126 could be performed for any picture 20 of the video. In order to being able to describe the process for a certain picture, Fdt is herein considered as a current picture 20a and Fₛₜ is considered as a reference picture 20c for the current picture 20a. The predetermined MVP 126, for example, is computed as the difference of the two projected points 136 and 138, MVP=qₛₒ−q_{do}.

The shortest distance 27 between the rays 26b and 26d dₘᵢₙ can be used as a measure of how well MVᵢ 130 tracks a static scene object and thus as a measure of suitability of the resulting predetermined MVP 126. The herein described geometrical derivation of the predetermined MVP 126, for example, is only performed for blocks of a current picture 20a associated with a static scene object like a background, furniture, buildings and plants.

In state of the art video coding, motion vector prediction is handled differently depending on the identity of Fₛᵢ, F_{di}, Fₛₜ and F_{dt}. The following sections describe these different cases and how the newly proposed method is applied in these cases.

Some note shall be made as to nomenclature and wording: Often, the verb “projected” is used along with an object/adverbial phrase “scene point” or “scene” and a further object/adverbial phrase “ . . . position of a . . . picture”. In such cases, the projection is meant to be defined by the video-geometry-related parameters 24 and specific for the “ . . . picture” mentioned (as the scene 14 to picture 20 mapping changes during the video 12). On the other hand, sometimes, an “offset” or “difference” between picture positions of different pictures 20 are mentioned. In that case, the projection does not play any role any more. The pictures 20 are assumed to form one common picture area which might be fixed over the whole video (i.e. fixed intrinsic camera parameters) or, at least, the picture area of one of the pictures 20 may be related to the picture area of the other picture by means of translator lateral (in-plane) offset and lateral (in-plane) stretching, e.g. isotropic or anisotropic so that differences or offsets of picture positions are invariant with respect to the picture positions absolute positions, but merely depend on the relative positions between them.

### Temporal Motion Vector Prediction

If the current picture 20a/F_{dt} is not equal to the source picture 20b/F_{di}, motion vector prediction in state of the art video coding uses temporal motion vector scaling to derive a motion vector predictor MVPₜₑₘₚ. Here, the source picture 20b/F_{di} is also called the co-located picture. In this case, MVPₜₑₘₚ is equal to a scaled input-MV MVᵢ and the scaling factor is chosen to match the temporal difference between the reference picture 20c/Fₛₜ and the current picture 20a/F_{dt}. Namely, if the picture order counts (POC) of the involved pictures are POC_{di}, POCₛᵢ, POC_{dt} and POCₛₜ, MVPₜₑₘₚ=MVᵢ*(POCₛₜ−POC_{dt})/(POCₛᵢ−POC_{di}).

In contrast to that, the newly proposed method, as described in the section above, derives a scene point 52b/fₘ from the input-MV MVᵢ, projects the scene point 52b/fₘ onto the reference picture 20c/Fₛₜ and the current picture 20a/F_{dt} obtaining projected points 136/qₛₒ and 138/q_{do} and calculates MVP_{temp,G}=qₛₒ−q_{do}. The motion vector MVP_{temp,G} may represent the predetermined MVP 126.

The video decoder 100 described with regard to FIG. 8 and FIG. 9 and the corresponding video encoder may be configured to derive the first MVP 130 from a (e.g. previously decoded/encoded) reference block 128 of a source picture 20b/F_{di}, and modify the first MVP 130 using the video-geometry-related parameters 24 by
using the video-geometry-related parameters 24, a first picture position 132/q_{di} of the
   reference block 128 and the first MVP 130,
   determining a first scene projection line 26b along which the scene 14 is (e.g. according to the video-geometry-related parameters 24 for the source picture 20b) projected onto the first picture position 132/q_{di} (e.g. the line connecting q_{di} and the camera projection center 31b, which, as visible in FIG. 8, traverses through the scene point 52a/f_{d}),
   determining a second scene projection line 26d along which the scene 14 is (e.g. according to the video-geometry-related parameters 24 for the further reference picture 20d) projected onto a second picture position 134/qₛᵢ of a further reference picture 20d onto which a head of the first MVP 130 points by placing a tail of the first MVP 130 onto the first picture position 132/q_{di} (note that any motion vector such as 130, while referring from one picture 20b to another 20d, corresponds to an in-plane reference picture vector 130′ pointing from a position 132′ co-located in the reference (ed) picture 20d relative to the control/block position 132 of the inter-predicted block 128 of the referencing picture 20b pointing to the position 134 pointed to by the motion vector 130), and
   determining a scene point (e.g. 52b/fₘ, 52a/f_{d} or 52c/fₛ) on a shortest line 51 (e.g. the line 51 connecting the scene point 52a/f_{d} and the scene point 52c/fₛ) connecting any point on the first scene projection line 26b and any point on the second scene projection line 26d (e.g., the shortest line 51 may connect the first scene projection line 26b and the second scene projection line 26d at a shortest distance between the first scene projection line 26b and the second scene projection line 26d in 3D space), and
using the video-geometry-related parameters 24 and the scene point 52,
   determining a third picture position 136/qₛₒ of a reference picture 20c/Fₛₜ onto which the scene point 52 is (e.g. according to the video-geometry-related parameters 24 for the reference picture 20c) projected,
   determining a fourth picture position 138/q_{do} of the current picture 20a/F_{dt} onto which the scene point 52 is (e.g. according to the video-geometry-related parameters 24 for the current picture 20a) projected,
   determining the predetermined MVP 126 so as to define an offset (e.g. difference) between the third picture position 136 and the fourth picture position 138.

As shown in FIG. 8, the scene point 52 may be determined as a mid point 52b/fₘ on the shortest line 51, in the mid of the shortest line, i.e. the scene point 52 may have the same distance to the first scene projection line 26b as to the second scene projection line 26d. The scene point 52, e.g., fₘ, may also be selected to be another point on the shortest line 51. For example, it is also possible that the scene point 52 is located somewhere else on the shortest line 51, e.g. nearer to the first scene projection line 26b than to the second scene projection line 26d, nearer to the second scene projection line 26d than to the first scene projection line 26b, directly on the first scene projection line 26b (see the scene point 52a/f_{d}) or directly on the second scene projection line 26d (see the scene point 52c/fₛ).

According to an embodiment, which will be described in the following in more detail,
if the source picture 20b equals the reference picture 20c/Fₛₜ, an intersection 52a/f_{d} of the shortest line 51 and the first scene projection line 26b may be considered as the scene point 52, and
if the further reference picture 20d equals the reference picture 20c, an intersection 52c/fₛ of the shortest line 51 and the second scene projection line 26d may be considered as the scene point 52, and
if the source picture 20b, the reference picture 20c and the further reference picture 20d are mutually different pictures, the mid point 52b on the shortest line 51 may be considered as the scene point 52.

In a special case, there are exactly three distinct pictures involved in TMVP (Temporal Motion Vector Prediction), i.e. if Fₛₜ=Fₛᵢ or Fₛₜ=F_{di} (note that Fₛᵢ can typically not be equal to F_{dt}). In this case, alternatively to projecting fₘ onto Fₛₜ, this projection calculation can be omitted. More specifically, if Fₛₜ=Fₛᵢ, qₛₒ can be chosen to be equal to qₛᵢ and if Fₛₜ=F_{di}, qₛₒ can be chosen to be equal to qui. Alternatively, instead of using qₛᵢ and qui directly, an intermediate point on the shortest line may be used for re-projection into Fₛₜ. For the projection into F_{dt}, fₘ may still be used. Alternatively, if Fₛₜ=Fₛᵢ, q_{do} can be chosen to be equal to the projection of fₛ onto F_{dt} and if Fₛₜ=F_{di}, q_{do} can be chosen to be equal to the projection of f_{d} onto F_{dt}.

In any of this cases the video decoder 100 and the corresponding video encoder may be configured to (e.g., using the video-geometry-related parameters 24, the first picture position 132 of the reference block 128 and the first MVP 130 derived from the reference block 128 of the source picture 20b/F_{di}),
determine the first scene projection line 26b along which the scene 14 is (e.g. according to the video-geometry-related parameters 24 for the source picture 20b) projected onto the first picture position 132/q_{di},
determine the second scene projection line 26d along which the scene 14 is (e.g. according to the video-geometry-related parameters 24 for the further reference picture 20d) projected onto the second picture position 134/qₛᵢ of the further reference picture 20d/Fₛᵢ onto which a head of the first MVP 130 points by placing a tail of the first MVP 130 onto the first picture position 132, and
determine a scene point 52 (e.g., one of 52a to 52c) on a shortest line 51 connecting any point on the first scene projection line 26b and any point on the second scene projection line 26d.

For example, if the source picture 20b/F_{di} equals the reference picture 20c/Fₛₜ, the video decoder 100 and the corresponding video encoder may be further configured to (e.g., using the video-geometry-related parameters 24 and the scene point 52)
determine the fourth picture position 138/q_{do} of the current picture 20a onto which the scene point 52 is (e.g. according to the video-geometry-related parameters 24 for the current picture 20a) projected, and
determine the predetermined MVP 126 so as to define an offset between the fourth picture position 138 and the first picture position 132/q_{di} or between the fourth picture position 138 and an intermediate picture position resulting from a projection of an intermediate point on the shortest line 51 between the scene point 52 and an intersection, see 52a/fd, of the shortest line 51 and the first scene projection line 26b onto the source picture 20b/F_{di}.

According to an embodiment, the intersection 52a/f_{d} of the shortest line 51 and the first scene projection line 26b may be considered as the scene point 52 and the video decoder 100 and the corresponding video encoder may be configured to determine the fourth picture position 138/q_{do} of the current picture 20a onto which the scene point 52 is projected, and determine the predetermined MVP 126 so as to define an offset between the fourth picture position 138 and the first picture position 132/q_{di}. Alternatively, it is also possible that the mid point 52b or any other point on the shortest line 51 may be considered as the scene point 52.

According to another embodiment, the mid point 52b may be considered as the scene point 52 or any point on the shortest line 51 between the intersection, see 52a/f_{d}, of the shortest line 51 and the first scene projection line 26b and the intersection, see 52c/fₛ, of the shortest line 51 and the second scene projection line 26d (including the intersection 52c/fₛ) may be considered as the scene point 52 (e.g., the intersection 52c/fₛ may also be possible as the scene point, but not the intersection 52a/f_{d}). In this case the video decoder 100 and the corresponding video encoder may be configured to determine the fourth picture position 138/q_{do} of the current picture 20a onto which the scene point 52 is projected, and determine the predetermined MVP 126 so as to define an offset between the fourth picture position 138 and an intermediate picture position resulting from a projection of an intermediate point on the shortest line 51 between the scene point 52 and an intersection, see 52a/f_{d}, of the shortest line 51 and the first scene projection line 26b onto the source picture 20b/F_{di}.

For example, if the further reference picture 20d/Fₛᵢ equals the reference picture 20c/Fₛₜ, the video decoder 100 and the corresponding video encoder may be configured to (e.g., using the video-geometry-related parameters 24 and the scene point 52)
determine the fourth picture position 138/q_{do} of the current picture 20a onto which the scene point 52 is (e.g. according to the video-geometry-related parameters 24 for the current picture 20a) projected, and
determine the predetermined MVP 126 so as to define an offset between the fourth picture position 138 and the second picture position 134/qₛᵢ or between the fourth picture position 138 and a further intermediate picture position resulting from a projection of a further intermediate point on the shortest line 51 between the scene point 52 and an intersection, see 52c/fₛ, of the shortest line 51 and the second scene projection line 26d onto the further reference picture 20d/Fₛᵢ.

According to an embodiment, the intersection 52c/fₛ of the shortest line 51 and the second scene projection line 26d may be considered as the scene point 52 and the video decoder 100 and the corresponding video encoder may be configured to determine the fourth picture position 138/q_{do} of the current picture 20a onto which the scene point 52 is projected, and determine the predetermined MVP 126 so as to define an offset between the fourth picture position 138 and the second picture position 134/qₛᵢ. Alternatively, it is also possible that the mid point 52b or any other point on the shortest line 51 may be considered as the scene point 52.

According to another embodiment, the mid point 52b may be considered as the scene point 52 or any point on the shortest line 51 between the intersection, see 52a/f_{d}, of the shortest line 51 and the first scene projection line 26b and the intersection, see 52c/fₛ, of the shortest line 51 and the second scene projection line 26d (including the intersection 52a/f_{d}) may be considered as the scene point 52 (e.g., the intersection 52a/f_{d} may also be possible as the scene point, but not the intersection 52c/fₛ). In this case the video decoder 100 and the corresponding video encoder may be configured to determine the fourth picture position 138/q_{do} of the current picture 20a onto which the scene point 52 is projected, and determine the predetermined MVP 126 so as to define an offset between the fourth picture position 138 and a further intermediate picture position resulting from a projection of a further intermediate point on the shortest line 51 between the scene point 52 and the intersection, see 52c/fₛ, of the shortest line 51 and the second scene projection line 26d onto the further reference picture 20d/Fₛᵢ.

For example, if the source picture 20b, the reference picture 20c and the further reference picture 20d are mutually different pictures, the video decoder 100 and the corresponding video encoder may be configured to (e.g., using the video-geometry-related parameters 24 and the scene point 52)
determine the third picture position 136/qₛₒ of the reference picture 20c onto which the scene point 52 is (e.g. according to the video-geometry-related parameters 24 for the reference picture 20c) projected,
determine the fourth picture position 138/q_{do} of the current picture 20a onto which the scene point 52 is (e.g. according to the video-geometry-related parameters 24 for the current picture 20a) projected, and
determine the predetermined MVP 126 so as to define an offset between the third picture position 136 and the fourth picture position 138.

The predetermined MVP 126, also denoted as MVP_{temp,G} herein, resulting from the newly proposed method can be used additionally to other MVPs, e.g. it can be added to the MVP list, or it can be used as an alternative to the temporal motion vector predictor MVPₜₑₘₚ. For example, the predetermined MVP 126 may be inserted into the list of MVP candidates as a substitute of a temporally predicted MVP or the first MVP 130.

For example, the video decoder 100 may be configured to reconstruct the current block 124 using the predetermined MVP 126 by inserting the predetermined MVP 126 into a list of MVP candidates, selecting a selected MVP out of the list of MVP candidates, and reconstructing the current block 124 using the selected MVP. Similarly the corresponding encoder may be configured to encode the current block 124 using the predetermined MVP 126 by inserting the predetermined MVP 126 into a list of MVP candidates, selecting a selected MVP out of the list of MVP candidates, and encoding the current block 124 using the selected MVP. The encoder is optionally configured to encode an index into the data stream 16, wherein the index indexes the selected MVP out of the list of MVP candidates. Respectively, the video decoder 100 may be configured to decode the index, e.g., pointing into the list of MVP candidates, from the data stream 16, and select the selected MVP out of the list of MVP candidates using the index.

Using a threshold d_{active}, the condition dₘᵢₙ<d_{active} can be used to determine whether or not MVP_{temp,G} is used as an additional MVP. In case MVP_{temp,G} is used as an alternative for MVPₜₑₘₚ, such a condition can determine whether or not MVP_{temp,G} replaces MVPₜₑₘₚ.

For example, the video decoder 100 and the corresponding video encoder may be configured to determine a quality measure based on a length measure of the shortest line 51 (e.g. the length, e.g., see 27 in FIG. 8 of the shortest line 51, or the length of a projection of the shortest line 51 onto the source picture 20b/F_{di} and/or onto the further reference picture 20d/Fₛᵢ or onto the current picture 20a/F_{dt} or onto the reference picture 20c/Fₛₜ or any other picture), and insert the predetermined MVP 126 into the list of MVP candidates provided that the quality measure meets a predetermined criterion (e.g. is smaller than a predetermined criterion, e.g., smaller than a predetermined length measure). According to an embodiment, the predetermined MVP 126 may be inserted into the list of MVP candidates as a substitute of a temporally predicted MVP or the first MVP 130 provided that the quality measure meets a predetermined criterion.

### Spatial Motion Vector Prediction

The case F_{dt}=F_{di}, i.e. the current picture 20a is equal to the source picture 20b, is called spatial motion vector prediction, i.e. input-MV and target-MV have the same destination picture. This case involves two or three different pictures, namely the single shared destination picture, i.e. the current picture 20a, and additionally one or two source pictures (one if Fₛₜ=Fₛᵢ and two otherwise; i.e. the reference picture 20c and/or the further reference picture 20d).

In the three-picture case (i.e. the source pictures are different; i.e. Fₛₜ #Fₛᵢ), VVC does not use such input-MVs for MVP. In contrast to that, the newly proposed method, as described in the section above, derives a scene point 52, e.g., 52b/fₘ, from the first MVP 130 MVᵢ, projects the scene point 52 onto the reference picture 20c/Fₛₜ and the current picture 20a/F_{dt} obtaining projected points qₛₒ and q_{do}, i.e. the third picture position 136 and the fourth picture position 138 and calculates the predetermined MVP 126, e.g. so as to define an offset (e.g. a difference) between the third picture position 136 and the fourth picture position 138, e.g., by MVP_{spatial,G}=qₛₒ−q_{do}.

The spatial motion vector prediction can be applied to generate MVPs for translational predicted blocks as well as for affine predicted blocks. That is, per control point of the affine predicted block, such as certain corners of the affine predicted block of the current picture, a spatially predicted vector, e.g., the first MVP 130, would be modified in the manner described above and the procedure would even compensate for the spatially predicted motion vectors possibly stemming referencing different reference pictures.

As described above with respect to FIG. 8 and FIG. 9, the video decoder 100 and the corresponding video encoder may be configured to derive the first MVP 130 from a (e.g. previously decoded/encoded) reference block 128 of a source picture 20b/F_{di}, and modify the first MVP 130 using the video-geometry-related parameters 24 by
using the video-geometry-related parameters 24, a first picture position 132/q_{di} of the reference block 128 and the first MVP 130,
   determining a first scene projection line 26b along which the scene 14 is (e.g. according to the video-geometry-related parameters 24 for the source picture 20b) projected onto the first picture position 132/q_{di} (e.g. the line connecting q_{di} and the camera projection center 31b, which, as visible in FIG. 8, traverses through the scene point 52a/f_{d}),
   determining a second scene projection line 26d along which the scene 14 is (e.g. according to the video-geometry-related parameters 24 for the further reference picture 20d) projected onto a second picture position 134/qₛᵢ of a further reference picture 20d onto which a head of the first MVP 130 points by placing a tail of the first MVP 130 onto the first picture position 132/q_{di} (note that any motion vector such as 130, while referring from one picture 20b to another 20d, corresponds to an in-plane reference picture vector 130′ pointing from a position 132′ co-located in the reference (ed) picture 20d relative to the control/block position 132 of the inter-predicted block 128 of the referencing picture 20b pointing to the position 134 pointed to by the motion vector 130), and
   determining a scene point (e.g. 52b/fₘ, 52a/f_{d} or 52c/fₛ) on a shortest line 51 (e.g. the line 51 connecting the scene point 52a/f_{d} and the scene point 52c/fₛ) connecting any point on the first scene projection line 26b and any point on the second scene projection line 26d (e.g., the shortest line 51 may connect the first scene projection line 26b and the second scene projection line 26d at a shortest distance between the first scene projection line 26b and the second scene projection line 26d in 3D space), and
using the video-geometry-related parameters 24 and the scene point 52,
   determining a third picture position 136/qₛₒ of a reference picture 20c/Fₛₜ onto which the scene point 52 is (e.g. according to the video-geometry-related parameters 24 for the reference picture 20c) projected,
   determining a fourth picture position 138/q_{do} of the current picture 20a/F_{dt} onto which the scene point 52 is (e.g. according to the video-geometry-related parameters 24 for the current picture 20a) projected,
   determining the predetermined MVP 126 so as to define an offset (e.g. difference) between the third picture position 136 and the fourth picture position 138,
      wherein the current block 124 and the reference block 128 are within one picture and the current picture 20a equals the source picture 20b. Optionally, the reference block 128 may equal the current block 124.

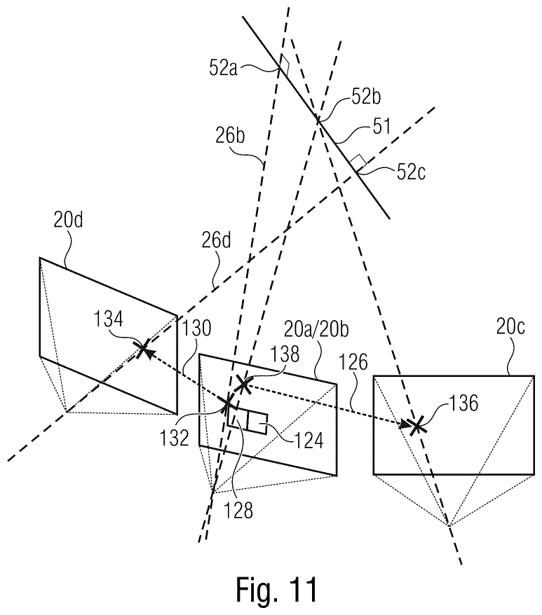

As exemplarily shown in FIG. 11, the video decoder 100 and the corresponding video encoder may be configured to derive the first MVP 130 from the reference block 128 (e.g., a block in a previously decoded/encoded spatial neighborhood of the current block 124) of the current picture 20a, and modify the first MVP 130 using the video-geometry-related parameters 24 by
using the video-geometry-related parameters 24, the first picture position 132 of the reference block 128 and the first MVP 130,
   determining the first scene projection line 26b along which the scene 14 is (e.g. according to the video-geometry-related parameters 24 for the current picture 20a) projected onto the first picture position 132,
   determining a second scene projection line 26d along which the scene 14 is (e.g. according to the video-geometry-related parameters 24 for the further reference picture 20d) projected onto a second picture position 134 of the further reference picture 20d onto which a head of the first MVP 130 points by placing a tail of the first MVP 130 onto the first picture position 132 (note that any motion vector such as 130, while referring from one picture 20a to another 20d, corresponds to an in-plane reference picture vector pointing from a position co-located in the reference (ed) picture 20d relative to the control/block position 132 of the inter-predicted block 128 of the referencing picture 20a pointing to the position 134 pointed to by the motion vector 130), and
   determining the scene point 52 (e.g. one of 52a to 52c) on the shortest line 51 connecting any point on the first scene projection line 26b and any point on the second scene projection line 26d, and
using the video-geometry-related parameters 24 and the scene point 52,
   determining a third picture position 136 of a reference picture 20c onto which the scene point 52 is (e.g. according to the video-geometry-related parameters 24 for the reference picture 20c) projected,
   determining a fourth picture position 138 of the current picture 20a onto which the scene point 52 is (e.g. according to the video-geometry-related parameters 24 for the current picture 20a) projected,
   determining the predetermined MVP 126 so as to define an offset (e.g. difference) between the third picture position 136 and the fourth picture position 138.

As described above and shown in FIG. 8 and FIG. 11, the scene point 52 may be determined as a mid point 52b/fₘ on the shortest line 51, in the mid of the shortest line, i.e. the scene point 52 may have the same distance to the first scene projection line 26b as to the second scene projection line 26d. The scene point 52, e.g., fₘ, may also be selected to be another point on the shortest line 51. For example, it is also possible that the scene point 52 is located somewhere else on the shortest line 51, e.g. nearer to the first scene projection line 26b than to the second scene projection line 26d, nearer to the second scene projection line 26d than to the first scene projection line 26b, directly on the first scene projection line 26b (see the scene point 52a/f_{d}) or directly on the second scene projection line 26d (see the scene point 52c/fₛ).

In the three-picture case, alternatively to projecting the mid point 52b/fₘ onto the current picture 20a/Fat, this projection calculation can be omitted by choosing q_{do} to be equal to qui, i.e. choosing the fourth picture position 138 to be equal to the first picture position 132. In this case, the video decoder 100 and the corresponding video encoder may be configured to determine the predetermined MVP 126 so as to define an offset between the third picture position 136 and the first picture position 132 or between the third picture position 136 and an intermediate picture position resulting from a projection of an intermediate point on the shortest line 51 between the scene point 52 and an intersection 52a of the shortest line 51 and the first scene projection line 26d onto the current picture 20a. Also, alternatively to projecting the mid point 52b/fₘ onto the reference picture 20c/Fₛₜ, qₛₒ can be chosen to be equal to the projection of f_{d} onto Fₛₜ, i.e. the third picture position 136 can be chosen to be equal to the projection of the scene point 52a onto the reference picture 20c. In other words, the scene point 52 can be the intersection 52a of the shortest line 51 and the first scene projection line 26d.

In the two picture case, the MVP derived by VVC is equal to the input-MV. The newly proposed method can calculate multiple predetermined MVP 126, e.g., also denoted as MVP_{spatial,G}, not equal to the input-MV in case f_{d} is not equal to fₛ, i.e. in case the scene point 52a is not equal to the scene point 52c. A predetermined MVP 126 can be derived by projecting any point p on the shortest line 51 connecting 52a/f_{d} and 52c/fₛ onto 20c/Fₛₜ and 20a/F_{dt} to obtain projected points 136/qₛₒ and 138/q_{do}. In particular, p=f_{d}, p=fₛ, or p=fₘ can be chosen.

According to an embodiment, the video decoder 100 and the corresponding video encoder may be configured to distinguish between the three picture case and the two picture case.

For example, the video decoder 100 and the corresponding video encoder may be configured to modify the first MVP 130 using the video-geometry-related parameters 24 by
using the video-geometry-related parameters 24, the first picture position 132 of the reference block 128 and the first MVP 130,
   determining the first scene projection line 26b along which the scene 14 is (e.g. according to the video-geometry-related parameters 24 for the source picture which is represented by the current picture 20a) projected onto the first picture position 132/q_{di},
   determining the second scene projection line 26d along which the scene 14 is (e.g. according to the video-geometry-related parameters 24 for the further reference picture 20d) projected onto a second picture position 134/qₛᵢ of the further reference picture 20d/Fₛᵢ onto which a head of the first MVP 130 points by placing a tail of the first MVP 130 onto the first picture position 132, and
   determining the shortest line 51 connecting any point on the first scene projection line 26b and any point on the second scene projection line 26d, and
using the video-geometry-related parameters 24 and the shortest line 51, if the further reference picture 20d/Fₛᵢ is different from the reference picture 20c/Fₛₜ which the predetermined MVP 126 relates to
   determining the scene point 52 as the mid point 52a of the shortest line 51, in the mid of the shortest line 51, or as the intersection 52a/f_{d} of the shortest line 51 and the first scene projection line 26b,
   determining the third picture position 136/qₛₒ of the reference picture 20c onto which the scene point 52 is (e.g. according to the video-geometry-related parameters 24 for the reference picture 20c) projected,
   determining the predetermined MVP 126 so as to define an offset
      between the third picture position 136 and the first picture position 132/q_{di} or
      between the third picture position 136 and an intermediate picture position resulting from a projection of an intermediate point on the shortest line 51 between the scene point 52 and an intersection 52a/f_{d} of the shortest line 51 and the first scene projection line 26b onto the source picture 20b/F_{di} or
      between the third picture position 136 and the fourth picture position 138/q_{do} resulting from a projection of the scene point 52 (e.g., being the mid point 52b) onto the current picture 20a, and
if the further reference picture 20d/Fₛᵢ is equal to the reference picture 20c/Fₛₜ,
   determining the scene point 52 as a point on the shortest line 51,
   determining the third picture position 136/qₛₒ of the reference picture 20c onto which the scene point 52 is (e.g. according to the video-geometry-related parameters 24 for the reference picture 20c) projected,
   determining a fourth picture position 138/q_{do} of the current picture 20a onto which the scene point 52 is (e.g. according to the video-geometry-related parameters 24 for the current picture 20a) projected,
   determining the predetermined MVP so as to define an offset between the third picture position 136 and the fourth picture position 138.

Optionally, if the further reference picture 20d/Fₛᵢ is equal to the reference picture 20c/Fₛₜ, the scene point 52 may be the intersection 52a/f_{d} of the shortest line 51 and the first scene projection line 26b, the intersection 52c/fₛ of the shortest line 51 and the second scene projection line 26d, or the mid point 52b of on the shortest line 51, in the mid of the shortest line 51.

The motion vector predictor MVP_{spatial,G} resulting from the newly proposed method can be used additionally to other MVPs, e.g. it can be added to the MVP list. Using a threshold d_{active}, the condition dₘᵢₙ<d_{active} can be used to determine whether or not MVP spatial, G is used as an additional MVP. This options can be implemented as described in the subsection temporal motion vector prediction.

### Motion Vector Derivation Considering-Camera Rotation Without Position Change

In case all cameras involved in the prediction of an image point have the same position, no particular 3d intersection point, i.e. scene point 52, is determined from the two images 20d/Fₛᵢ and 20b/F_{di}. Instead, the ray originating from either one of the first two cameras associated to the images 20d/Fₛᵢ and 20b/F_{di}, e.g. the first scene projection line 26b or the second scene projection line 26d, is intersected with the image camera plane of the third camera associated to 20c/Fₛₜ resp. 20a/F_{dt} and the resulting point is the predicted image point 136/qₛₒ resp. 138/q_{do}. As an alternative to that, the two rays 26b and 26d originating from the first two cameras (with direction vectors dirₛᵢ and dir_{di}) are both used by calculating a third ray with direction vector dirᵢ=0.5*(dirₛᵢ+dir_{di}) and intersecting the third ray with the camera plane of the third camera, while the intersection point is the predicted image point 136/qₛₒ resp. 138/q_{do}.

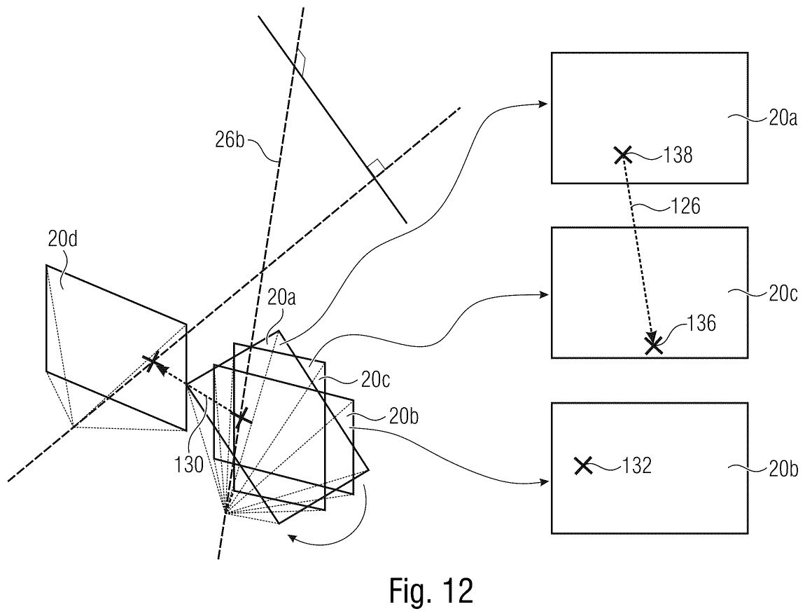

Accordingly a herein described video decoder 100 and corresponding video encoder may be configured to derive the predetermined motion vector predictor 126 by deriving, for the current block 124, a first MVP 130 from a previously decoded portion 128 of the video, and modifying the first MVP 130 using the video-geometry-related parameters 24 so as to obtain the predetermined MVP 126 by checking camera positions indicated by the video-geometry-related parameters 24 and performing a geometric derivation depending on the camera positions (see FIG. 12 to FIG. 14):

For example, as shown in FIG. 12, if the current picture 20a, the reference picture 20c and the source picture 20b are associated with the same camera position (but, e.g., not with the same camera orientation; i.e. there is no translative change between the cameras of the pictures only a rotational change), the geometric derivation of the predetermined MVP 126 may be performed by
determining a first scene projection line 26b along which the scene 14 is (e.g. according to the video-geometry-related parameters 24 for the source picture 20b) projected onto a first picture position 132 of a reference block 128 in the source picture 20b (as explained with regard to FIG. 9, the reference block 128 in the source picture 20b may be co-located to the current block 124 in the current picture 20a),
determining a third picture position 136 of the reference picture 20c as an intersection of the first scene projection line 26b with the reference picture 20c,
determining a fourth picture position 138 of the current picture 20a as an intersection of the first scene projection line 26b with the current picture 20a, and
determining the predetermined MVP 126 so as to define an offset (e.g. a difference) between the third picture position 136 and the fourth picture position 138.

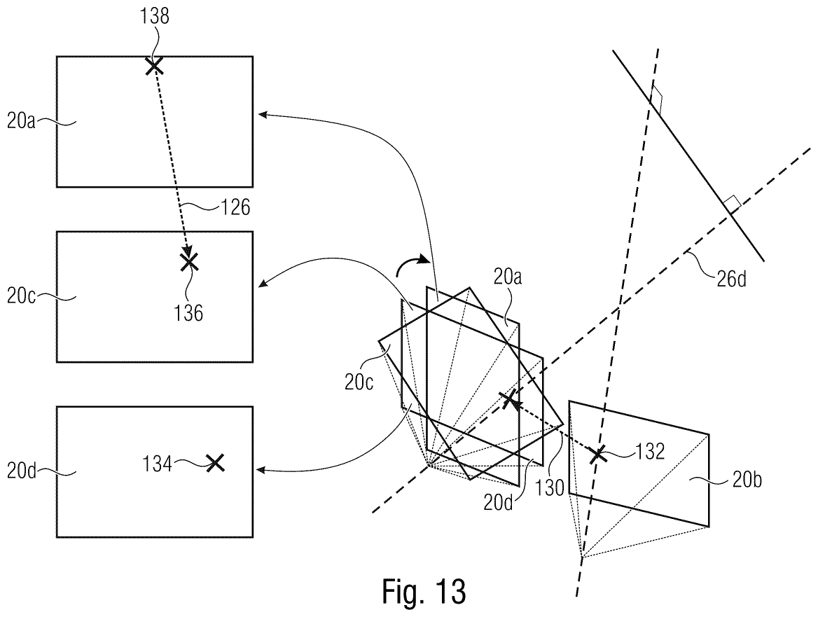

For example, as shown in FIG. 13, if the current picture 20a, the reference picture 20c and the further reference picture 20d are associated with the same camera position (but, e.g., not with the same camera orientation; i.e. there is no translative change between the cameras of the pictures only a rotational change), the geometric derivation of the predetermined MVP 126 may be performed by
determining a second scene projection line 26d along which the scene 14 is (e.g. according to the video-geometry-related parameters 24 for the further reference picture 20d) projected onto a second picture position 134 of the further reference picture 20d onto which a head of a first MVP 130 derived from the reference block 128 points by placing a tail of the first MVP 130 onto the first picture position 132,
determining a third picture position 136 of the reference picture 20c as an intersection of the second scene projection line 26d with the reference picture 20c,
determining a fourth picture position 138 of the current picture 20a as an intersection of the second scene projection line 26d with the current picture 20a, and
determining the predetermined MVP 126 so as to define an offset (e.g. a difference) between the third picture position 136 and the fourth picture position 138.

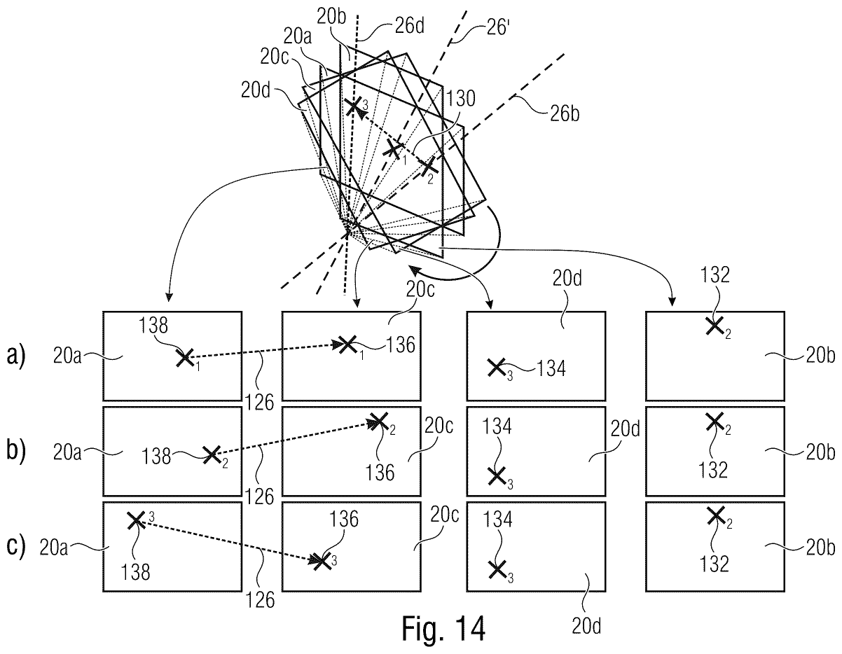

For example, as shown in FIG. 14, if the current picture 20a, the reference picture 20c, the source picture 20b and the further reference picture 20d are associated with the same camera position (but, e.g., not with the same camera orientation; i.e. there is no translative change between the cameras of the pictures, only a rotational change), the geometric derivation of the predetermined MVP 126 may be performed by

Option a) determining the first scene projection line 26b along which the scene 14 is (e.g. according to the video-geometry-related parameters 24 for the source picture 20b) projected onto the first picture position 132 of the reference block 128 in the source picture 20b (as explained with regard to FIG. 9, the reference block 128 in the source picture 20b may be co-located to the current block 124 in the current picture 20a),
determining the second scene projection line 26d along which the scene is (e.g. according to the video-geometry-related parameters 24 for the further reference picture 20d) projected onto the second picture position 134 of the further reference picture 20d onto which the head of the first MVP 130 derived from the reference block 128 points by placing the tail of the first MVP 130 onto the first picture position 132,
determining a third scene projection line 26′ based on the first scene projection line 26b and the second scene projection line 26d, wherein the third scene projection line 26′ is associated with an arithmetic mean of the first scene projection line 26b and the second scene projection line 26d,
determining a third picture position 136 of the reference picture 20c as an intersection of the third scene projection line 26′ with the reference picture 20c, and
determining a fourth picture position 138 of the current picture 20a as an intersection of the third scene projection line 26′ with the current picture 20a,
determining the predetermined MVP 126 so as to define an offset (e.g. a difference) between the third picture position 136 and the fourth picture position 138; or

Option b) determining the first scene projection line 26b along which the scene 14 is (e.g. according to the video-geometry-related parameters 24 for the source picture 20b) projected onto a first picture position 132 of the reference block 128 in the source picture 20b,
determining a third picture position 136 of the reference picture 20c as an intersection of the first scene projection line 26b with the reference picture 20c,
determining a fourth picture position 138 of the current picture 20a as an intersection of the first scene projection line 26b with the current picture 20a, and
determining the predetermined MVP 126 so as to define an offset (e.g. a difference) between the third picture position 136 and the fourth picture position 138;
or

Option c) determining the second scene projection line 26d along which the scene 14 is (e.g. according to the video-geometry-related parameters 24 for the further reference picture 20d) projected onto the second picture position 134 of the further reference picture 20d onto which the head of the first MVP 130 derived from the reference block 128 points by placing the tail of the first MVP 130 onto the first picture position 132,
determining a third picture position 136 of the reference picture 20c as an intersection of the second scene projection line 26d with the reference picture 20c,
determining a fourth picture position 138 of the current picture 20a as an intersection of the second scene projection line 26d with the current picture 20a, and
determining the predetermined MVP 126 so as to define an offset (e.g. a difference) between the third picture position 136 and the fourth picture position 138.

The video decoder 100 and corresponding video encoder may be configured to, e.g., by default, perform only one of options a) to c). For example, The option available for the video decoder 100 and corresponding video encoder may be predefined and the other options may not be selectable. Alternatively, the video decoder 100 and corresponding video encoder may be configured to select block-wise one of options a) to c). Thus, all options a) to c) may be available to the video decoder 100 and the corresponding video encoder.

For example, else, i.e. if none of the above defined camera position conditions apply, the video decoder 100 and corresponding video encoder may be configured to modifying the first MVP 130 using the video-geometry-related parameters 24 so as to obtain the predetermined MVP 126 as described above, e.g., in this section (i.e., in the section “2 Motion vector prediction”), e.g., see “Temporal Motion Vector Prediction” and “Spatial Motion Vector Prediction”. Optionally, the video decoder 100 and corresponding video encoder may be configured to check only one of the camera position conditions, i.e. the camera position condition explained with regard to FIG. 12 or FIG. 13 or FIG. 14, and else, i.e. if the respective camera position condition is not fulfilled, modify the first MVP 130 using the video-geometry-related parameters 24 so as to obtain the predetermined MVP 126 as described above, e.g., in this section (i.e., in the section “2 Motion vector prediction”), e.g., see “Temporal Motion Vector Prediction” and “Spatial Motion Vector Prediction”.

### 3 Motion Compensated Sample Prediction (e.g., Using a Scene Model)

In the following embodiments describing a new motion compensated sample prediction is introduced.

### Scene Model

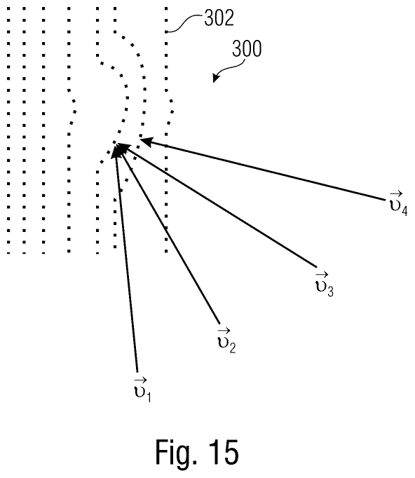

In a variant, e.g., see FIG. 15, an intermediate scene-model 300 is used (like a mesh or point cloud) to gather information of the scene 14 during the decoding/encoding process.

The scene point estimation, e.g., as described above in the section “2 Motion vector prediction”, can be used to determine for each inter predicted block one or more scene points 52 (e.g., based on which scene-model points 302 of the scene model 300 may be derivable) depending on the used inter prediction mode. To be more precise, the scene point estimation is to determine a scene model 300 (or 3D scene model) for each decoded picture 20 based on the respective picture's motion vectors assuming, or with selecting among same so, that these motion vectors describe primarily the disparity among the two camera perspectives of their underlying pictures, i.e. the respective picture and the reference picture (e.g., see the motion vectors 46 described with respect to FIG. 7). MVs describing (primarily) real scene motion might be excluded from the estimation. The scene model 300 may, thus, be built after a decoding of a certain picture for this picture (e.g., after a decoding of a current picture 20a), in order to be used for subsequently to be decoded pictures. As said, the estimation uses the MVs of inter-predicted blocks. Advantageously, the scene model building may help to estimate scene model areas for which there are possibly no MVs available due to, for instance, intra-prediction modes being selected for blocks in such areas. Inter/extrapolation might be used to this end. The scene model estimation may rely on the above concepts of finding scene point 52b/fₘ (or similar points) in the scene 14. The distance between the scene points 52a/f_{d} and 52c/fₛ might be used to exclude certain MVs from participating in contributing to the scene model estimation.

With translational motion one scene point 52 derived by the scene point estimation can be used to determine the distance dsp between the object in the scene 14 and the camera or the picture. In a next step the corner points of the predicted block (or the source block) are projected into the scene 14 with the same dsp, the obtained scene point distance (spanning a rectangular parallel to the picture plane), see the vectors \vec{v}₁ to \vec{v}₄ in FIG. 15. Thus, the scene model 300 may be defined by a plurality of this projected rectangles or by scene-model points 302 to which the vectors \vec{v}₁ to \vec{v}₄ point or by a plurality of scene points 52 representing the scene-model points 302.

For affine predicted blocks, depending on the used affine model (4 or 6 parameter model) the model is expanded to yield an 8-parameter model, and the scene point estimation is used to derive a scene point 52 for each of the 4 control points, see the control points 44 described with respect to FIG. 7, at the block corners individually. The encoder does the same for the encoded pictures based on the encoded motion vectors so that decoder and encoder may use the same scene model 300 for MVP determination and/or sample prediction.

For example, a herein described video decoder and corresponding video encoder may be configured to determine the scene model 300 based on the pictures' motion vectors, e.g. based on the first MVP's 130 of the current picture 20a or based on the first MVP's 130 of a previously decoded/encoded picture (e.g., based on the first MVP's of the inter predicted blocks of the current or the previously decoded/encoded picture), and based on the video-geometry-related parameters 24. The video decoder 100 and the corresponding video encoder, as described with regard to FIG. 8 to FIG. 14, may be configured to use the scene model 300 and the video-geometry-related parameters 24 to determine the predetermined MVP 126. The video decoder 10 and the corresponding video encoder, as described with regard to FIG. 5 to FIG. 7, may be configured to use the scene model 300 and the video-geometry-related parameters 24 to find in the (e.g. previously decoded/encoded) reference picture 20b the corresponding pixels 23.

The scene model 300 (e.g. determined for a predetermined picture (pP) (e.g. the current picture after decoding/encoding) based on that picture's MVs exclusively or determined for this picture based on its MVs and MVs of one or more previous (e.g. previously decoded/encoded) pictures) can be determined (e.g., by a herein described video decoder or video encoder) by for each of one or more control points (CP) (e.g., the herein described first picture position 132 may represent a control point) of an inter-predicted block (e.g., the herein described reference block 128) of a predetermined picture 20b, determining a scene-model point 302 for forming a basis of the scene model 300 (e.g. the scene model 300 is then determined based on the scene-model points 302, such as by the scene points 52 contributing to a point cloud of the scene model 300, or forming a vertex of a facial area (e.g. triangle) of a mesh of the scene model 300). The determination of the scene-model point 302 for each of one or more control points of an inter-predicted block can be performed by
determining a source picture position (sPP) (e.g., the herein described second picture position 134 may represent the source picture position) in a corresponding reference picture (CRP) (e.g., the herein described further reference picture 20d may represent the cRP) to which a motion vector (e.g., the herein described first MVP130) points from the respective control point, which is coded in the data stream for the inter-predicted block for the respective control point,
using the video-geometry-related parameters 24,
   determining a first scene projection line 26b along which the scene 14 is (e.g. according to the video-geometry-related parameters 24 for the predetermined picture (e.g., 20b)) projected onto the respective control point (e.g., q_{di}/132),
   determining a second scene projection line 26d along which the scene 14 is (e.g. according to the video-geometry-related parameters 24 for the corresponding reference picture (e.g., 20d)) projected onto the source picture position (see qₛᵢ/134) (onto which a head of the MV 130 points by placing a tail of the MV 130 onto the respective control point), and
   determining a scene point 52 (e.g. 52b/fₘ, 52a/f_{d}, or 52c/fₛ) on a shortest line 51 (e.g. line connecting 52a/f_{d} and 52c/fₛ) connecting any point on the first scene projection line 26b and any point on the second scene projection line 26d, and
   determining the scene-model point 302 to be the scene point 52, or
      by determining a distance of the scene point 52 from the predetermined picture (see 20b) and determining the scene-model point 302 to be on the first scene projection line 26b at the distance.

The scene model 300, for example, is a mesh or a point cloud.

Optionally scene-model points 302 for which a quality measure determined based on a length measure of the shortest line 51 does not meet a predetermined criterion (e.g. is not smaller than a predetermined maximum length, e.g., see the herein described condition dₘᵢₙ<d_{active}).

According to an embodiment one control point (CP) (e.g. one corner of these blocks such as the upper left corner) is used for translational inter-predicted blocks, and/or more than one control point (CP) (e.g. two or more corners of these blocks) are used for affine inter-predicted blocks.

The obtained scene points 52 associated with the predicted blocks can be stored as mesh with two triangles, using the scene points of the projected block corners, being the triangles corner points. When using a point cloud each of the scene points 52 can be stored in the point cloud or alternatively a sample-wise back-projection enclosed by the projected block can be stored in the point cloud.

The intermediate scene model can optionally be updated with decoder motion information considering the current decoded picture only, or alternatively building the scene-model 300 incorporating motion information from several decoded pictures, that might be delimited by the temporal layers (e.g. only TemporalLayer<Threshold_{TL} can contribute to the model). In a variant the scene-model 300 is refined and used over an intra-period and reset at the next random access-point (e.g., see the below).

The scene model 300 may additionally be determined based on motion vectors of inter-predicted blocks of one or more previous pictures (e.g., previous decoded/encoded pictures).

Optionally, the determination of the scene model 300 can be restricted with respect to inter-predicted blocks of pictures of a temporal layer fulfilling a predetermined criterion (e.g. temporal base layer up to a predetermined maximum temporal layer).

### Scene Model Refinement

When the scene model 300 is build using motion information from multiple decoded pictures, a weighting of the scene points 52 according to their relevance might be beneficial. For example, scene points 52 stemming from an affine predicted block are preferred over scene points 52 stemming from a translational predicted block in the same scene area, as well as translational modes are preferred over merge or skip modes, under the assumption that, with RD-optimized encoding/decoding, complex prediction modes with higher rate costs, as the affine mode, produce more precise prediction with less distortion, leading to a better scene model 300. In contrast, a measure that evaluates the presence or the energy of the transmitted residual signal e.g. a higher number of residual coefficients or a higher sum of the absolute values associated with the predicted block would decrease the preference of the respective scene points 52.

For example, determining the scene model 300 may be performed
preferred based on scene-model points 302 which stem from motion vectors of inter-predicted blocks coded in the affine mode compared to scene-model points 302 which stem from motion vectors of a translatory mode, and/or
preferred based on scene-model points 302 which stem from motion vectors of inter-predicted blocks whose motion vectors are coded in the data stream individually for these blocks compared to scene-model points 302 which stem from motion vectors of inter-predicted blocks coded in skip, direct or merge mode, and/or
at a preference varying among the scene-model points 302 in a manner so that the preference is the higher the lower a prediction residual signal coded into the data stream is according to a predetermined measure for the inter-predicted blocks from the motion vectors of which the scene-model points 302 stem, and/or
at a preference varying among the scene-model points 302 in a manner so that the preference is the higher the temporally nearer the picture of the inter-predicted blocks is from the motion vectors of which the scene-model points 302 stem, and/or
at a preference varying among the scene-model points in a manner so that the preference is the higher the lower the quantizer step size of the inter-predicted blocks is from the motion vectors of which the scene-model points 302 stem.

The herein described video decoder and the corresponding video encoder may be configured to, in using the scene model 300 and the video-geometry-related parameters 24 to determine the predetermined MVP 126 (e.g., the video decoder 100 and the corresponding video encoder as described with regard to FIG. 8 to FIG. 14) or in using the scene model 300 and the video-geometry-related parameters 24 to derive the block inner (e.g., the video decoder 10 and the corresponding video encoder as described with regard to FIG. 5 to FIG. 7), rely on portions (e.g. points of the point cloud or facial areas of the mesh) of the scene model 300 at a weight which is higher for portions which stem from motion vectors of inter-predicted blocks coded in the affine mode than for portions which stem from motion vectors of a translatory mode, and/or
higher for portions which stem from motion vectors of inter-predicted blocks whose motion vectors are coded in the data stream individually for these blocks than for to portions which stem from motion vectors of inter-predicted blocks coded in skip, direct or merge mode, and/or
is the higher the lower a prediction residual signal coded into the data stream is according to a predetermined measure for the inter-predicted blocks from the motion vectors of which the portions stem, and/or
is the higher the temporally nearer the picture of the inter-predicted blocks is from the motion vectors of which the portions stem, and/or
is the higher the lower the quantizer step size of the inter-predicted blocks is from the motion vectors of which the portions stem.

Note: That is, it might be that the construction of the scene model 300 is based on all scene-model points 302 and is done, for instance, for each picture 20 again, but the construction prefers certain scene-model points 302 in the construction over others such as in case of several scene-model points 302 being close to each other so that the scene model 300 may be “thinned out” in that area. The resulting scene model 300 might then be used for MVP creation or warping as is, i.e. without distinguishing where the individual parts of the scene model 300 stemmed from. It is, however, possible that the scene model 300 becomes steadily larger and larger with additional scene-model points 302 and that the usage thereof in MVP creation or warping depends on the origin of the individual portions.

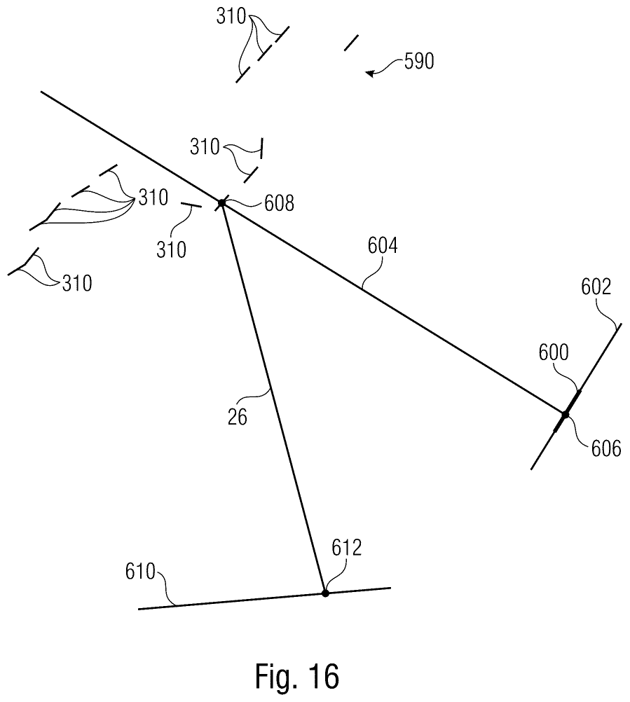

When using the mesh-based scene model (e.g., the scene model 300 with a mesh 590 as shown in FIG. 16) for prediction, for example, the destination position, see 132/q_{di}, is projected into the scene model 300 and the intersection point of the projected ray with the mesh triangle of the scene model 300 with the smallest distance between intersection point and camera, in front of the picture 20, is selected as scene-point PBPi 608 used for the back projection to determine the source point position, see 134/qₛᵢ.

As shown in FIG. 16, the video decoder 100 and the corresponding video encoder as described with regard to FIG. 8 to FIG. 14 may be configured to, in using the scene model 300 and the video-geometry-related parameters 24 to determine the predetermined MVP 126 for a current block 600 (corresponding to the current block 124 in FIG. 9) of a current picture 602 (corresponding to the current picture 20a in FIG. 9),
determine a scene projection line 604 along which the scene 14 is (e.g. according to the video-geometry-related parameters 24 for the current picture 602) projected onto a picture position 606 (e.g., a top left corner of the current block 600, or a center of the current block 600, or a bottom right corner of the current block 600) of the current block 600,
determine one finally used point 608 on the scene projection line 604 based on one or more intersection points 608 of the scene projection line 604 with facial areas 310 (e.g. with one or more of them, with one intersection point per facial area 310 intersected; e.g., the facial areas 310 may also be denoted as surface areas or rectangular areas or triangle areas or areas spanned by scene-model points 302 of the mesh 590) of a mesh 590 (e.g., whose vertices might have been recruited from scene-model points 302) of the scene model 300 (e.g. the nearest one), and
project 26 the finally used point 608 onto a reference picture 610 (corresponding to the reference picture 20c in FIG. 9) to which the predetermined MVP 126 refers so as to obtain a corresponding picture position 612 in the reference picture 610, and determine the predetermined MVP 126 to be the offset between the corresponding picture position 612 and the picture position 606.

As shown in FIG. 16, the video decoder 10 and the corresponding video encoder as described with regard to FIG. 5 to FIG. 7 may be configured to, in using the scene model 300 and the video-geometry-related parameters 24 to find in the (e.g. previously decoded/encoded) reference picture 610 (corresponding to the reference picture 20b in FIG. 5) the corresponding position 612 (corresponding to the corresponding position 22 in FIG. 2),
for each pixel 606 (corresponding to the pixels 23 in FIG. 5) in the current block 600 (corresponding to the current block 18 in FIG. 5),
   determine a scene projection line 604 along which the scene 14 is (e.g. according to the video-geometry-related parameters 24 for the current picture 602 (corresponding to the current picture 20a in FIG. 5)) projected onto the respective pixel 606 of the current block 600,
   determine one finally used point 608 on the scene projection line 604 based on one or more intersection points 608 of the scene projection line 604 with facial areas 310 (e.g. with one or more of them, e.g., with one intersection point per facial area 310 intersected; e.g., the facial areas 310 may also be denoted as surface areas or rectangular areas or triangle areas or areas spanned by scene-model points 302 of the mesh 590) of a mesh 590 (e.g., whose vertices might have been recruited from scene-model points 302) of the scene model 300 (e.g. the nearest one), and
   project 26 the finally used point 608 onto the reference picture 610 to obtain the corresponding position 612 corresponding to the respective pixel 606.

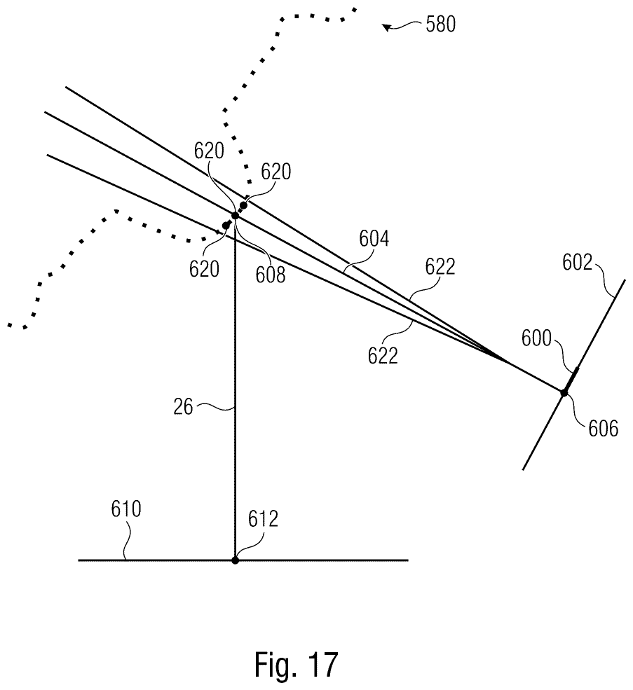

Alternatively, when using a point-cloud-based model (e.g., the scene model 300 with a point-cloud 580 as shown in FIG. 17) the destination position 606, see also 132/q_{di}, may span a virtual pyramid or a cone 622 with the vertex at the camera position and the center line passing through the destination position 606, see also 132/q_{di}. All points 620 of the point cloud within the cone 622 or pyramid, that are in front of the picture 602, are considered as valid candidates to derive a scene-point 608 PBPi used for the back projection to determine the source point position 612, see also 134/qₛᵢ. The scene point 608 PBPi used for back projection might be derived by averaging the first N points with the smallest distance to the camera, or alternatively by selecting the point with the smallest distance to the cones or pyramids center line 604. The back-projected ray 26 from the scene point 608 PBPi into the camera point of the source picture 610 intersect the picture at the position 612, see also 134/qₛᵢ, producing the final motion vector MVᵢ=qₛᵢ-q_{di} for the position i. If the projection of the destination position 606, see also 132/q_{di} into the scene 14 does not intersect any mesh triangle of the scene model 300 or none of the intersection scene points are in front of the picture, the source point position 612, see also 134/qₛᵢ, can not be determine and no MVᵢ is available for this position.

As shown in FIG. 17, the video decoder 100 and the corresponding video encoder as described with regard to FIG. 8 to FIG. 14 may be configured to, in using the scene model 300 and the video-geometry-related parameters 24 to determine the predetermined MVP 126 for a current block 600 (corresponding to the current block 124 in FIG. 9) of a current picture 602 (corresponding to the current picture 20a in FIG. 9),
determine a scene projection line 604 along which the scene 14 is (e.g. according to the video-geometry-related parameters 24 for the current picture 602) projected onto a picture position 606 (e.g., a top left corner of the current block 600, or a center of the current block 600, or a bottom right corner of the current block 600) of the current block 600,
determine one finally used point 608 based on one or more points 620 (same might have been recruited directly from scene-model points 302) of a point cloud 580 of the scene model 300 falling into a cone 622 or pyramid widening away from the picture point 606 (or from a camera point associated with the current picture 602, wherein a center axis (e.g., the scene projection line 604) of the cone 622 intersects with the picture point 606) and surrounding the scene projection line 604, and
project 26 the finally used point 608 onto a reference picture 610 (corresponding to the reference picture 20c in FIG. 9) to which the predetermined MVP 126 refers to obtain a corresponding point 612 in the reference picture 610, and determine the predetermined MVP 126 to be the offset between the corresponding picture position point 612 and the picture position 606.

As shown in FIG. 17, the video decoder 10 and the corresponding video encoder as described with regard to FIG. 5 to FIG. 7 may be configured to, in using the scene model 300 and the video-geometry-related parameters 24 to find in the (e.g. previously decoded/encoded) reference picture 610 (corresponding to the reference picture 20b in FIG. 5) the corresponding position 612 (corresponding to the corresponding position 22 in FIG. 2),
for each pixel 606 (corresponding to the pixels 23 in FIG. 5) in the current block 600 (corresponding to the current block 18 in FIG. 5),
   determine a scene projection line 604 along which the scene 14 is (e.g. according to the video-geometry-related parameters 24 for the current picture 602 (corresponding to the current picture 20a in FIG. 5)) projected onto the respective pixel 606 of the current block 600,
   determine one finally used point 608 based on one or more points 620 of a point cloud 580 of the scene model 300 falling into a cone 622 or pyramid widening away from the respective pixel 606 (or from a camera point associated with the current picture 602, wherein a center axis (e.g., the scene projection line 604) of the cone 622 intersects with the respective pixel 606) and surrounding the scene projection line 604,
   project 26 the finally used point 608 onto the reference picture 610 to obtain the corresponding position 612 corresponding to the respective pixel 606.

### Z-Buffer

The Z-buffer is a data structure keeping track of depth information for each pixel of a picture. The Z-buffer stores the depth value (z-value) for each pixel of the picture. The depth value represents the distance from the camera to the object surface in the scene 14 that projects onto that pixel. The Z-buffer is usually implemented as a 2D array where each element corresponds to a pixel of the picture and stores the depth value of the closest object to the camera that maps to that pixel.

In a variant the scene model 300 is used to derive z-values for all sample positions in a specific picture and store these z-values in a z-buffer. In combination with the camera parameter, e.g., comprised by the video-geometry-related parameters 24, of the specific picture, for each sample position in the specific picture a projection from the camera position into the scene 14 is performed. If the projected ray (e.g., see 604 in FIG. 16 and FIG. 17) of a particular sample position (e.g., see 606 in FIG. 16 and FIG. 17) intersects one or more mesh triangles in the scene 14, the distance, in camera direction, between the camera point and the nearest intersection point (e.g., see 608 in FIG. 16 and FIG. 17), that is in front of the projection plane, is stored as z-value for the sample position in the z-buffer. For samples were the projection does not intersect any mesh triangle, or the intersection point is behind the projection plane of the picture, the z-value is treated as unknown.

The prediction from the z-buffer might be improved by predicting valid z-values into regions with unknown z-values. The z-buffer might be organized as a picture plane-buffer having a width and a height according to the picture size.

One variant can fill holes using bilinear interpolation of the surrounding valid z-samples and extrapolate z-values at the z-buffer boundaries, in x and y direction. Especially for motion vector prediction, an extrapolation with a fix or dynamic margin into unknown z-value regions might be beneficial.

Dynamic margin extrapolation could be implemented as kind of quad tree. The z-buffer is partitioned into initial blocks. For each block the valid z-values covered by the block are used to estimate a planar z-value-approximation minimizing the sum of squared error between all valid z-values in the block and the approximated z-value-plane. The sum of squared errors extended by an adjustment-term are treated as costs for the block. The examined block is then divided into 4 quad-tree subblocks recursively performing the described approximation. At block level the minimum of the costs of the sum of costs of the subblock and the cost of current block is chosen to determine an optimal quad-tree. The quad-tree estimation is performed for each initial block recursively down to some minimum blk size. In the end, for the best determined quad-tree, the estimated z-planes values for the best sub-partitioned blocks found are used to replace the z-value in the z-buffer.

The adjustment-term is used to balance the precision of the approximated planes versus the extension of the valid z-values into regions with invalid z-values.

The motion vector MVᵢ (see 130 in FIG. 8 to FIG. 14) for a position (see 132/q_{di} in FIG. 8 to FIG. 14) is obtained by selecting the z-value from the z-buffer of the destination picture, and perform a projection from the camera point (see 31b in FIG. 8) through the point 132/q_{di} into the scene 14 and use the z-value to determine the distance between the scene-point PBPi (see 52a in FIG. 8 to FIG. 14) on the projection ray (see 26b in FIG. 8 to FIG. 14) in camera direction and the camera point 31b. The obtained scene point PBPi 52a is then back-projected into the camera point (see 31d in FIG. 8) of the source picture (see 20d in FIG. 8 to FIG. 14) and intersect the picture at the position 134/qₛᵢ, producing the final motion vector MVᵢ=qₛᵢ-q_{di}, i.e. the predetermined MVP 126 for the position i. This method may be used by the video decoder 100 and corresponding video encoder described above in the section “2 Motion vector prediction” to derive the predetermined MVP 126 for a current block 124 in a current picture 20a.

This method may also be used by the video decoder 10 and corresponding video encoder described above in the section “1 Temporal sample prediction” to find for each pixel 23 in the current block 18 a respective corresponding position 22. For example, the video decoder 10 and the corresponding video encoder may be configured to, for each pixel 23 of the current picture 20a, select the z-value from the z-buffer of the current picture 20a and perform a projection 26 from the camera point (e.g., derived from the video-geometry-related parameters 24 for the current picture 20a) through the respective pixel 23 into the scene 14 and use the z-value to determine the distance between the scene-point on the projection ray in camera direction and the camera point. The respective obtained scene point is then back-projected into the camera point (e.g., derived from the video-geometry-related parameters 24 for the reference picture 20b) of the reference picture 20b and intersects the reference picture 20b at the respective corresponding position 22 corresponding to the respective pixel 23.

For example, a herein discussed video decoder and corresponding video encoder may be configured to, in using the scene model 300 and the video-geometry-related parameters 24 to determine the predetermined MVP 126 (e.g., the video decoder 100 and corresponding video encoder of FIG. 8 to FIG. 14) or in using the scene model 300 and the video-geometry-related parameters 24 to derive the block inner (e.g., the video decoder 10 and corresponding video encoder of FIG. 5 to FIG. 7),
construct a depth map (e.g., see the above described z-buffer) by, for each pixel of pixels of the current picture 20a, measuring a distance from the respective pixel onto the scene model 300 along which the scene 14 is (e.g. according to the video-geometry-related parameters 24 for the current picture 20a) projected onto the respective pixel so as to determine a depth value of the depth value at the respective pixel,
apply interpolation onto the depth map in order to determine depth values for pixels for which the scene model 300 is not hit or sufficiently close to a scene projection line (e.g., along which the scene 14 is projected onto the respective pixel),
use the depth map and the video-geometry-related parameters 24 to determine the predetermined MVP (e.g., performed by the video decoder 100 and corresponding video encoder of FIG. 8 to FIG. 14) or
use the depth map and the video-geometry-related parameters 24 to derive the block inner (e.g., performed by the video decoder 10 and corresponding video encoder of FIG. 5 to FIG. 7).

### Sample Prediction

The embodiments described in this subsection may comprise features and or functionalities as described with regard to the video decoder 10 and corresponding video encoder of the section “1 Temporal sample prediction” and vice versa.

The scene model 300 can also be used for direct sample prediction. The predicted sample block can be obtained by using either of the above described methods to determine the sample position 134/qₛᵢ in the source picture, i.e., the corresponding position 22 in the reference picture 20b (see FIG. 5). The integer part of 134/qₛᵢ, for example, determines the sample position (e.g., the respective corresponding position 22 in FIG. 5) in pel-units, whereas the fractional part of 134/qₛᵢ, for example, is used to select the according interpolation filters in x and y direction, to obtain the prediction sample from a subsample position. Interpolation filters used to produce samples at subsample position could be interpolation filters like VTM 8Tap or ECM 12Tap filters used for motion compensation, or other interpolation filters.

In a variant the sampling of the prediction block is executed sample-wise. If the 134/qₛᵢ cannot be determined, for example, the affected prediction sample is marked as invalid.

In another variant the prediction block is divided into subblocks, for each subblock a single 134/qₛᵢ is determined with 132/q_{di} (e.g., corresponding to a pixel 23 in FIG. 5) being a position in the subblock (e.g. the center position in the subblock; e.g., in a subblock of the current block 18 in FIG. 5), yielding a motion vector MVᵢ=qₛᵢ−q_{di} per subblock. With the motion vector all samples of the subblock are predicted. If no 134/qₛᵢ could be determined the affected entire subblock is marked invalid.

After prediction of the samples, samples that are marked as invalid in the prediction block are, for example, derived using bilinear interpolation and/or extrapolation from valid neighboring samples.

### Explicit Mode

Scene model sample prediction might be signaled as individual inter prediction-mode, using a flag transmitted in the bitstream indicating its usage.

### Generate Reference Picture

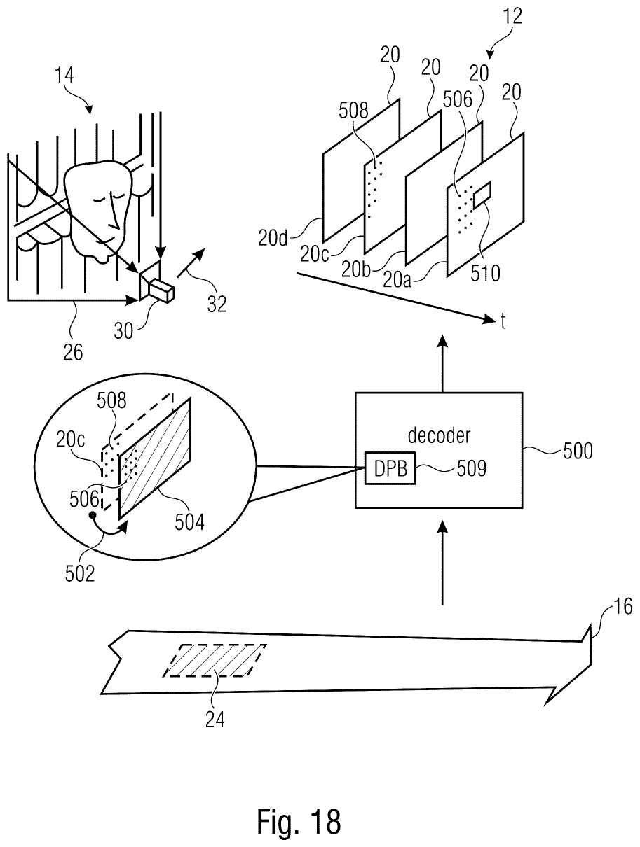

The scene model 300 can be used to create an additional scene model based reference picture (SMBRP), e.g., denoted as synthesized reference picture 504 (see FIG. 18) in the following, inserted in one or both reference picture lists. The SMBRP can be accessed by addressing the generated reference picture via the syntax element ref-idx. The samples of the reference pictures can be created, as described above (e.g., see the first part of this subsection, i.e. of the subsection “Sample Prediction”), treating the reference picture as a large prediction block. In a first step valid samples are, for example, stored in the buffer.

As shown in FIG. 18, a video decoder 500 for decoding a video 12 of a scene 14 from a data stream 16 using motion-compensated prediction (and also a corresponding video encoder for encoding a video 12 of a scene 14 into a data stream 16 using motion-compensated prediction) can be configured to construct 502 a synthesized reference picture 504, synthesized so as to form a synthesized version of a predetermined picture (e.g. a current picture 20a or some other previous picture such as 20b so that the pixels of these pictures, i.e. the synthesized one and the picture the synthesized version of which the synthesized picture represents, become synonym), by finding in a (e.g. previously decoded) reference picture (e.g. 20c) corresponding positions 508, corresponding to pixels 506 in the predetermined picture (e.g. 20a), using video-geometry-related parameters 24 (or, using a different term: video-capturing-related parameters; irrespective of the term used, and with this also being valid for the whole application and the claims, the parameters shall also include the case that the video 12 is synthetically generated by means of, for example, an artificial intelligence, a neural network or using 3D rendering) describing how the scene 14 is projected onto pictures 20 of the video 12, and sampling the reference picture 20c at the corresponding positions 508. Additionally, the video decoder 500 is configured to derive, for a current portion of a current picture (e.g., a block 510 in picture 20a), a portion inner by sampling a corresponding portion of the synthesized reference picture 504, and reconstruct the current portion 510 using the portion inner. A corresponding encoder may be configured to also derive, for the current portion 510 of the current picture, a portion inner by sampling a corresponding portion of the synthesized reference picture 504 and then encode the current portion 510 using the portion inner.

The video decoder 500 and the corresponding video encoder may be configured to determine a scene model 300 based on the pictures' motion vectors and the video-geometry-related parameters (e.g., as described above in this section, i.e. in the section “3 Motion Compensated Sample Prediction”), and use the scene model 300 and the video-geometry-related parameters 24 to find in the (e.g. previously decoded/encoded) reference picture 20c the corresponding positions 508.

The synthesized reference picture 504 may be constructed by finding in the (e.g. previously decoded/encoded) reference picture 20c the corresponding positions 508 (e.g., each of which may correspond to a respective picture position 612 shown in FIG. 16 and FIG. 17) using the scene model 300 and the video-geometry-related parameters 24 and by sampling the reference picture 20c at the corresponding positions 508. The corresponding positions 508 can be found by, for each pixel 506 (e.g., corresponding to the picture position 606 shown in FIG. 16 and FIG. 17) in the predetermined picture (e.g. the current picture 20a, e.g., corresponding to the current picture 602 shown in FIG. 16 and FIG. 17), determining a scene projection line (e.g., see 604 in FIG. 16 and FIG. 17) along which the scene 14 is (e.g., according to the video-geometry-related parameters 24 for the predetermined picture) projected onto the respective pixel 506, determining a finally used scene point (e.g., see 608 in FIG. 16 and FIG. 17) based on an intersection of the scene projection line (e.g., see 604 in FIG. 16 and FIG. 17) and the scene model 300 (e.g. see 580 in FIG. 17 or 590 in FIG. 16) (e.g. using cone and point cloud or using triangles of scene model), and projecting the finally used point (e.g., see 608 in FIG. 16 and FIG. 17) onto the reference picture 20c (e.g., see 610 in FIG. 16 and FIG. 17) to obtain the corresponding position 508 corresponding to the respective pixel 506.

The current portion 510 can be reconstructed or encoded using the synthesized reference picture 504 by copying a co-located portion of the synthesized reference picture 504, co-located to the current portion 510; or by copying/sampling a portion of the synthesized reference picture 504, pointed to by a motion vector coded for the current portion 510 (which might be an inter-predicted block).

Additionally, or alternatively, the current portion 510 can be reconstructed using the synthesized reference picture 504 by selecting the synthesized reference picture 504 out of a list of reference pictures in a decoded picture buffer DPB 509 using a reference index coded into the data stream 16 for the current portion 510. The current portion 510 can be encoded using the synthesized reference picture 504 by encoding the reference index into the data stream 16 for selecting the synthesized reference picture out of the list of reference pictures in the decoded picture buffer DPB 509, i.e. so that the synthesized reference picture is selectable out of the list of reference pictures in the decoded picture buffer DPB 509.

Additionally, or alternatively, the synthesized reference picture 504 can be reconstructed or constructed by use of one or more further reference pictures in order to subsidiary determine the synthesized reference picture 504 at pixels of the current picture 20a for which no corresponding pixel is found in the reference picture 20c.

To deal with effects like occlusion and others, the SMBRP, i.e. the synthesized reference picture 504, might be derived from more than on source pictures, i.e. from two or more reference pictures, e.g., comprising the above mentioned reference picture 20c and the one or more further reference pictures. For each source picture (reference picture) a temporary buffer may be filled as described in above (e.g., in this subsection “Sample Prediction”), treating the temporary buffer as prediction block. In a next step the SMBRP samples are derived by selecting the first valid sample entry from all temporary buffers at the same sample location (Note: the order of source pictures is important for reconstruction). If all the temporary buffers contain invalid sample values at the sample location then the corresponding SMBRP sample is also marked invalid. In a final step, samples at sample positions marked as invalid are filled up with valid sample values using bilinear interpolation and extrapolation of sample values from valid neighbor positions.

In other words, the synthesized reference picture 504 may be constructed by use of interpolation/extrapolation in order to subsidiary determine the synthesized reference picture 504 at pixels 506 of the current picture 20a for which no corresponding pixel/position 508 is found in any reference picture, e.g., in reference picture 20a and in the one or more further reference pictures.

The source pictures, i.e. reference pictures, to derive the synthesized reference picture 504 from might be signaled in the bitstream, i.e. the data stream 16, in another variant the source pictures are the first picture in the reference lists.

The position at which the synthesized reference picture 504 is inserted into the reference picture list or lists, might be signaled in the bitstream 16, if not signaled in the bitstream 16 the position is a predetermined position in the list (e.g. the last position in the list). The synthesized reference picture 504 could replace the reference picture at the specific position or append the reference list, implying a modification of num_ref_idx (in order to access all reference pictures).

The preferred configuration using a synthesized reference picture 504, is to append each reference picture list with one synthesized reference picture 504 at the end of the reference_picture_list. The synthesized reference picture 504 inserted in RPL_L0 is derived from the first picture in the RPL_L0 and the first picture in RPL_L1, if available. If available, the synthesized reference picture 504 inserted in RPL_L1 is derived from the first picture in the RPL_L1 and the first picture in RPL_L0.

### Motion Vector Prediction

The scene model based reference picture (SMBRP), i.e. the synthesized reference picture 504, is a motion compensated representation of the current picture 20a derived from a reconstructed reference picture 20c from the reference buffer. Note that “motion compensated representation” meant here that the synthesized reference picture 504 has been created by means of camera based MC (motion compensation) or homography—the synthesized reference picture 504 is quasi a warped version of the source/reference picture 20c using additionally camera orientation and camera positions of the current picture 20a, i.e. currFrame, and source/reference frame 20c.

When using samples from the synthesized reference picture 504, the motion vectors that refer the source samples, for example, implicitly refer to an already motion compensated representation of the reconstructed reference picture 20c.

If the synthesized reference picture 504 is used for prediction, the actual motion vector field used for the prediction is a superposition of the scene model based motion compensation and the used motion vector to offset the source block in the synthesized reference picture 504.

According to an embodiment, motion vectors referencing the synthesized reference picture 504 can be modified for sake of temporal motion vector prediction for one or more inter-predicted blocks of other pictures and/or spatial motion vector prediction for one or more inter blocks of the current picture by adding to the motion vectors a motion vector determined by the video-geometry-related parameters 24 and describing a disparity between portions referenced by the motion vectors in the synthesized reference picture 504 and blocks of referencing pictures at which the motion vectors are applied.

The superimposed MV-Field can be used for motion vector prediction, for example when accessing the reference picture 20c that was used as source to derive the synthesized reference picture 504.

Temporal motion vector prediction can be redirected for prediction from the synthesized reference picture 504 to the reference picture 20c (e.g. so as to derive MVP candidates, e.g., 126, from the reference picture instead).

A general approach to correct the motion vectors is to superimpose the underlying motion on a fixed block grid within the prediction block, dividing the latter into subblocks (e.g. smallest possible, for each 4×4 block). The sample-wise motion vectors of the underlying motion vector field associated to each subblock are averaged subblock-wise and superimposed with the motion vector used to address the sample block in the synthesized reference picture 504.

For affine predicted blocks the subblock-wise superimposed approach combines the averaged sample wise motion vectors of the underlying motion vector field with the affine motion vectors derived at the subblocks position.

In the case the current block 510 is predicted using common translational prediction from the picture used as source picture, i.e. the reference picture 20c, for the synthesized reference picture 504 and a neighbor block was predicted from the synthesized reference picture 504, then the superimposed MV can be used as MVP candidate, (the MV prediction would treat the synthesized reference picture 504 and the source picture, i.e. the reference picture 20c, for the synthesized reference picture 504 as prediction from the same picture).

In contrast in the case the current block 510 is predicted from the synthesized reference picture 504 and a neighbor block is not, then the prediction sources are treated as different pictures, and the MV for this neighbor block is not available for MV prediction.

For example, the current block 510 can be reconstructed or encoded using the predetermined MVP 126 by warping pixel positions in the current block 510 onto corresponding pixel positions, e.g., 506 or 508, of the reference picture, e.g., of the synthesized reference picture 504 or the reference picture 20b, using the video-geometry-related parameters 24 and the predetermined MVP 126.

### 4 Coding of Camera Parameters

In a variant of the proposed approach, the camera parameters, e.g., comprised by the video-geometry-related parameters 24, are not derived at the decoder and thus are transmitted in the bitstream 16. The camera parameters for a particular frame, e.g., a current picture 20a, may include the camera position (x, y, z), and the camera orientation expressed in Euler-angles (α, β, γ) or as a quaternion (x₀,x₁,x₂,x₃), furthermore the focal length (f) and optional parameters for more complex camera models may be comprised by the camera parameters. The camera parameters, for example, have a floating point value range.

### Quantization of Camera Parameters

The values read from the bitstream 16 associated with the camera parameters have to be mapped, at decode side, from binary code words onto the camera parameters. In a variant of the embodiment the binary code mapping uses unary vlc as used in VVC resp. signed vlc to produce intermediate integer values. A dequantizer with uniform quantization step size can be used to map the intermediate integer values into value range of the camera parameter.

The quantization step size for the camera parameters QP_{Cam} can be derived by the quantization parameter send in the ParameterSet for the video QP_{Cam}=f(QP_{Video})+DeltaQP_{Cam}, where DeltaQPcam could be transmitted in the bitstream 16 or derived by some suitable parameter (e.g. TemporalLayer of an associated picture).

A variant for quantization of the camera parameters is to transmit the exponent and the mantissa of the floating-point values of the camera parameters as two fixed length codes.

### Prediction of Camera Parameters

In a video scene the camera parameters associated to consecutive frames are likely similar and thus prediction of camera parameters from previous reconstructed camera parameters can help to reduce the required bits for transmission. Under the assumption camera parameters are transmitted in display order and steady camera movement, a particular camera parameter p_{x,n} transmitted for frame fₙ is predicted from the camera parameter of the previous reconstructed camera parameter p_{x,n-1} associated with the frame fₙ₋₁, with the difference dp_{x,n} transmitted in the bitstream (p_{x,n}=P_{x,n-1}+dp_{x,n}).

In a further variant, under the assumption of smooth and steady camera movement also the dp_{x,n} can be predicted from its predecessor dp_{x,n}=dp_{x,n-1}+dp2_{x,n} forming a 2^{nd} level prediction, where dp2_{x,n} is transmitted in the bitstream instead of dp_{x,n}.

### Coding Camera Parameters at Picture Level

Since camera parameters are associated to a particular frame, e.g., the current picture 20a, the transmission of camera parameters within slice-header or picture-header is proposed in a variant of the embodiment.

In other words, the video-geometry-related parameters 24 can be encoded into a slice-header or picture-header or decoded from the slice-header or picture-header within access units of the data stream 16 relating to the pictures 20 of the video 12.

A flag in the picture header or slice header can be used to signal the existence of the camera parameters syntax elements in the header. If the camera parameters are present one of the quantization and/or prediction schemes are used to transmit the camera parameters.

### Coding Camera Parameters at GOP Level

In this variant of the embodiment camera parameters for multiple pictures (e.g. Intra-period or GOP) are transmit in a single data block. The data block could be transmitted in the picture header or slice header using a flag to indicate the existence of the camera parameter data block or in another variant the block can be encapsulated in an APS. However, the block-wise approach provides the option to straight forward combine the above mentioned prediction and quantization schemes.

### Coding of MVs at Control Points

In contrast to the use of camera parameters the information about the position and the orientation of the frames can be signaled with a set of motion vectors 46 at specific control points 44, e.g., see FIG. 7. Where the motion vectors 46 describe the displacement at the control points 44 of the current picture, e.g. 40₂, relative to a reference picture, e.g. 40₁. That is, according to this option, the video-geometry-related parameters 24 contain, for a picture, one vector 46 per corner of that picture, and these vectors 46 describe the offset of the corners' positions from their corresponding positions in some “reference picture”. The latter picture may be the immediately preceding picture—in terms of coding or presentation time order- or may be another picture. The pictures form, thus, a pair (a,b) with a and b being, for instance, the POC of the picture for which the vectors 46 are transmitted in the data stream 16 as part of the video-geometry-related parameters 24, and b is the associated “reference” picture. For instance, such pairs may be defined to follow the GOP structure interdependencies between the pictures of a GOP. For sake of achieving knowledge on the effective vectors 46 for the corners of a certain picture a with respect to a predetermined reference picture x, decoder and encoder may simply concatenate (add) the video-geometry-related parameters' vectors 46 for the corners for picture pairs (a,b), (b,c), (c, . . . ) . . . ( . . . ,x) with selecting, for instance, the smallest such sequence of picture pairs for which there are vectors 46 in the video-geometry-related parameters 24. When for the current picture a and the reference picture b for the current block, the video-geometry-related parameters 24 contain the corners' vectors for pair (a,b), no such concatenation is necessary. The vector mapping or homomorphismus is realized by using the effective vectors as supporting vectors for some interpolation 48 to yield the mapped vectors for certain positions to be mapped to. For instance, the homomorphism realized by the corners' vectors for pair picture (a,b) may represent a mapping 42 which maps picture points in picture a onto corresponding points in picture b with, for instance, assuming that mutually corresponding points in these pictures a and b lie, in the scene 14, in a scene plane 50. This scene plane 50 may, for instance, be a background plane of the captured scene 14 such as a wall or the like, e.g. the book shelf behind the head in the foreground illustrated in scene 14. For instance, to obtain a MVP for a current block of a current picture a, the MVP relating to reference picture b, the interpolation may be used to map the picture position of the current block onto a corresponding position and use the difference as the predetermined MVP possibly added to a list of MVP candidates as described above (e.g., see the section “2 Motion vector prediction”).

When camera intrinsic parameters are given, it is also possible to derive from the homomorphism (possibly multiple) solutions for extrinsic camera parameters and parameters defining this scene plane 50. Projection of any point in the scene plane 50 into that camera and into a camera at the origin defines the same mapping between the resulting image points as does the homomorphism. However, an MVP can be derived using these camera parameters by triangulation exactly like described above. That is, we are not limited to using the homomorphism-parameters only for following the homomorphic mapping between two pictures. We can also use them for triangulation using input-MVs exactly like above.

This might seem to collide with the view that the homomorphism is only defined between two pictures whereas camera parameters seem to stand for one picture and independently of other pictures. But this is just a question of the point of reference, i.e. we can choose any coordinate system for the (camera-) parameters: for example we can put the parameters of the first picture (of some group) at the origin and this means that all camera parameters are now relative to that picture. The same is true for homomorphism parameters. It would actually be bad to use an origin that is not equivalent to one useful set of parameters, as in effect we would waste description length (or bits) to have this useless origin. Put differently, the entropy coding will calculate differences and thus derive relative parameters anyway.

The control point vectors 46 may be seen, thus, as an alternative representation of the camera parameters defining the camera position and orientation. This alternative representation is possibly better adapted to entropy coding which might be used for coding parameters 24 into stream 16. The coding might include a quantizing of the parameters and the quantization errors of control point vectors proportionally cause errors in the image plane 50. Quantization errors of rotation angels or depth-related camera position errors are more difficult to control with respect to their consequences.

The predetermined motion vector predictor (MVP) 126 can, for example, be derived by using the video-geometry-related parameters 24 so as to map a picture position of the current block 124 onto a corresponding position in a reference picture which the predetermined MVP 126 is to refer to, and use an offset between the picture position and the corresponding position as the predetermined MVP 126.

When camera intrinsic parameters are given, it is also possible to derive from the homomorphism extrinsic camera parameters and parameters defining this scene plane 50. Multiple solutions may result from the derivation of extrinsic camera parameters from the homomorphism, i.e. the vectors at the picture corners, but a predetermined rule may be used to select one of these solutions both at decoder and encoder. That is, using the homomorphism-parameters, it is possible that encoder and decoder perform the triangulation based tasks described above in order to derive a predetermined MVP 126.

The video-geometry-related parameters, for example, describe a homomorphic mapping 42 between corresponding positions in pairs of pictures of the video 12 and a herein described video decoder is configured to derive, for a predetermined picture, e.g., the current picture 20a, a scene-to-picture projection projecting the scene 14 onto the predetermined picture based on the homomorphic mapping 42 between corresponding positions in pairs of pictures including the predetermined picture.

With respect to the discrepancy between the homomorphism-defining corner vectors which are defined between picture pairs on the one hand and the camera projection parameters such as the extrinsic ones which are defined for each picture individually, the following shall be noted: it is correct that the homomorphism is only defined between two pictures whereas camera parameters seem to stand for one picture and independently of other pictures. But this is just a question of the point of reference. We can choose any coordinate system for the (camera-) parameters: for example we can put the parameters of the first picture (or some group of pictures) at the origin and this means that all camera parameters are now relative to that picture. The same is true for homomorphism parameters. It would actually be bad to use an origin that is not equivalent to one useful set of parameters, as in effect we would waste description length (or bits) to have this useless origin. Put differently, the entropy coding will calculate differences and thus derive relative parameters anyway.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus. Analogously, an apparatus may comprise a hardware apparatus, like for example, a microprocessor, a programmable computer or an electronic circuit, configured to perform one or more method steps.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.
[1] Motion Vector Coding and Block Merging in Versatile Video Coding Standard; Wei-Jung Chien, L₁ Zhang, Martin Winken, Xiang Li, Ru-Ling Liao, Han Gao, Chih-Wie Hsu, Hongbin Liu, Chun-Chi Chen; IEEE Transaction on Circuits and Systems for Video Technology Vol. 31 No. 10; October 2021
[2] ITU-T and ISO/IEC JTC 1, “Versatile video coding (ITU-T Rec. H.266 and ISO/IEC 23090-3),” Aug. 2020.

I/We claim:

1. Video decoder for decoding a video of a scene from a data stream using motion-compensated prediction, configured to
derive, for a current block of a current picture, a predicted block inner by
finding in a reference picture corresponding positions, corresponding to pixels in the current block, using video-geometry-related parameters describing how the scene is projected onto pictures of the video, and
sampling the reference picture at the corresponding positions; and
reconstruct the current block using the predicted block inner.

2. Video decoder of claim 1, wherein the video-geometry-related parameters describe a scene-to-picture projection of one camera projecting the scene onto the pictures of the video.

3. Video decoder of claim 1, wherein the video-geometry-related parameters describe a scene-to-picture projection of one camera projecting the scene onto the pictures of the video for each picture of the video.

4. Video decoder of claim 1, wherein the video-geometry-related parameters describe a scene-to-picture projection of one camera projecting the scene onto the pictures of the video picture-wise and picture globally.

5. Video decoder of claim 1, wherein the video-geometry-related parameters describe the scene-to-picture projection by means of one or more of
one or more extrinsic camera parameters and
one or more intrinsic camera parameters of the one camera.

6. Video decoder of claim 5, wherein the one or more extrinsic camera parameters define a position of the one camera and/or an orientation of the one camera.

7. Video decoder of claim 5, wherein the one or more intrinsic camera parameters define a focal length and/or a FOV angle of the one camera.

8. Video decoder of claim 1, wherein the video-geometry-related parameters describe a homomorphic mapping between corresponding positions in pairs of pictures of the video or a homomorphic mapping between corresponding motion vectors relating to pairs of pictures of the video.

9. Video decoder of claim 8, wherein the video-geometry-related parameters describe the homomorphic mapping by means of vectors or tensors at predetermined control points of the video's pictures.

10. Video decoder of claim 9, wherein the predetermined control points are corners of the video's pictures.

11. Video decoder of claim 8, wherein the video-geometry-related parameters comprise, per picture, merely one vector or tensor for each of the four corners of the video's pictures.

12. Video decoder of claim 1, wherein the video-geometry-related parameters describe a homomorphic mapping between corresponding positions in pairs of pictures of the video and the video decoder is configured to derive, for a predetermined picture, a scene-to-picture projection projecting the scene onto the predetermined picture based on the homomorphic mapping between corresponding positions in pairs of pictures comprising the predetermined picture.

13. Video decoder of claim 1, configured to decode the video-geometry-related parameters from the data stream.

14. Video decoder of claim 1, configured to determine the video-geometry-related parameters based on an already decoded portion of the video.

15. Video decoder of claim 1, wherein the video-geometry-related parameters describe a homomorphic mapping between corresponding positions in pairs of pictures of the video and the video decoder is configured to derive, for a predetermined picture, a scene-to-picture projection projecting the scene onto the predetermined picture based on a sequence of the homomorphic mapping between corresponding positions in one or more pairs of pictures comprising the predetermined picture and a base picture and based on extrinsic and intrinsic parameters for the base picture.

16. Video decoder of claim 1, configured to decode a syntax element from the data stream, and
if the syntax element comprises a first state,
derive, for the current block, the predicted block inner by finding in the reference picture corresponding positions, corresponding to pixels in the current block, using video-geometry-related parameters describing how the scene is projected onto pictures of the video, and sampling the reference picture at the corresponding positions, and
reconstruct the current block using the predicted block inner.

17. Video decoder of claim 16, configured to if the syntax element comprises a second state,
reconstruct the current block independent from the video-geometry-related parameters, or
reconstruct the current block by copying an already decoded video portion at a regular inter-pixel pitch.

18. Video decoder of claim 1, configured to
derive a list of MVP candidates for the current block, one of the MVP candidates corresponding to a specific motion-vector-less inter-coding mode,
selecting a selected MVP out of the list of MVP candidates, and
reconstructing the current block using the selected MVP by
if the selected MVP corresponds to the specific motion-vector-less inter-coding mode,
deriving, for the current block, the predicted block inner by finding corresponding positions in the reference picture, corresponding to pixels in the current block, using video-geometry-related parameters describing how the scene is projected onto pictures of the video, and sampling the reference picture at the corresponding positions, and
reconstructing the current block using the predicted block inner,
if the selected MVP corresponds to a MVP candidate other than the specific motion-vector-less inter-coding mode,
reconstructing the current block using motion-vector-compensated prediction using the selected MVP.

19. Video decoder of claim 1, configured to
determine a scene model based on the pictures' motion vectors and the video-geometry-related parameters,
use the scene model and the video-geometry-related parameters to find in the reference picture the corresponding positions.

20. Video decoder of claim 1, configured to determine the scene model by
for each of one or more control points of an inter-predicted block of a predetermined picture, determining a scene-model point for forming a basis of the scene model, by
determining a source picture position in a corresponding reference picture to which a motion vector points from the respective control point, which is coded in the data stream for the inter-predicted block for the respective control point,
using the video-geometry-related parameters,
determining a first scene projection line along which the scene is projected onto the respective control point,
determining a second scene projection line along which the scene is projected onto the source picture position, and
determining a scene point on a shortest line connecting any point on the first scene projection line and any point on the second scene projection line, and
determining the scene-model point to be the scene point, or
by determining a distance of the scene point from the predetermined picture and determining the scene-model point to be on the first scene projection line at the distance.

21. Video decoder of claim 1, configured to determine the scene model by
for each of one or more control points of an inter-predicted block of a predetermined picture, determining a scene-model point for forming a basis of the scene model, by
determining a source picture position in a corresponding reference picture to which a motion vector points from the respective control point, which is coded in the data stream for the inter-predicted block for the respective control point,
using the video-geometry-related parameters,
determining a scene point by
determining a system of linear equations using the video-geometry-related parameters, the respective control point and the source picture position, and
solving the system of linear equations,
determining the scene-model point to be the scene point, or
by determining a distance of the scene point from the predetermined picture and determining the scene-model point to be on the first scene projection line at the distance.

22. Video decoder of claim 21, wherein the system of linear equations is defined by the equation AQ=0, wherein
Q represents a vector comprising the to be determined coordinates of the scene point, and
A represents a matrix defined by the video-geometry-related parameters, the respective control point and the source picture position.

23. Video decoder of claim 22, wherein the matrix A is defined by
A.row(0)=q_{di}(0)*am_{di}.row(2)−cam_{di}.row(0)
A.row(1)=q_{di}(1)*cam_{di}.row(2)−cam_{di}.row(1)
A.row(2)=qₛᵢ(0)*camₛᵢ.row(2)−camₛᵢ.row(0)
A.row(3)=qₛᵢ(1)*camₛᵢ.row(2)−camₛᵢ.row(1),
wherein the rows of the matrix A are denoted by A.row(0), A.row(1), A.row(2) and A.row(3)
wherein coordinates of the respective control point are denoted by q_{di}(0) and q_{di}(1),
wherein coordinates of the source picture position are denoted by qₛᵢ(0) and qₛᵢ(1), and
wherein the video-geometry-related parameters are denoted by cam_{di}.row(2), cam_{di}.row(0), cam_{di}.row(2), cam_{di}.row(1), camₛᵢ.row(2), camₛᵢ.row(0), camₛᵢ.row(2) and camₛᵢ.row(1).

24. Video decoder of claim 22, configured to perform solving the system of linear equations by using a singular value decomposition method.

25. Video decoder of claim 1, configured to determine the scene model by
for each of one or more control points of an inter-predicted block of a predetermined picture, determining a scene-model point for forming a basis of the scene model, by
determining a source picture position in a corresponding reference picture to which a motion vector points from the respective control point, which is coded in the data stream for the inter-predicted block for the respective control point,
using the video-geometry-related parameters,
determining a scene point by minimizing a cost function depending on re-projection errors,
determining the scene-model point to be the scene point, or
by determining a distance of the scene point from the predetermined picture and determining the scene-model point to be on the first scene projection line at the distance.

26. Video decoder of claim 25, wherein the re-projection errors associated with the respective control point of the inter-predicted block of the predetermined picture comprise
a distance between the respective control point of the inter-predicted block and a projection of the scene point onto the predetermined picture, and
a distance between the source picture position of the corresponding reference picture and a projection of the scene point onto the corresponding reference picture.

27. Video decoder of claim 26, wherein the scene model is a mesh or a point cloud.

28. Video decoder of claim 20, configured to dismiss scene-model points for which a quality measure determined based on a length measure of the shortest line does not meet a predetermined criterion.

29. Video decoder of claim 20, configured to
use one control point for translational inter-predicted blocks, and/or
use more than one control points for affine inter-predicted blocks.

30. Video decoder of claim 20, configured to, in determining the scene model, determine the scene model additionally based on motion vectors of inter-predicted blocks of one or more previous pictures.

31. Video decoder of claim 20, configured to restrict the determining the scene model with respect to inter-predicted blocks of pictures of a temporal layer fulfilling a predetermined criterion.

32. Video decoder of claim 19, configured to, in determining the scene model, determining the scene model
preferred based on scene-model point which stem from motion vectors of inter-predicted blocks coded in the affine mode compared to scene-model point which stem from motion vectors of a translatory mode, and/or
preferred based on scene-model point stem from motion vectors of inter-predicted blocks whose motion vectors are coded in the data stream individually for these blocks compared to scene-model point which stem from motion vectors of inter-predicted blocks coded in skip, direct or merge mode, and/or
at a preference varying among the scene-model points in a manner so that the preference is the higher the lower a prediction residual signal coded into the data stream is according to a predetermined measure for the inter-predicted blocks from the motion vectors of which the scene-model points stem, and/or
at a preference varying among the scene-model point in a manner so that the preference is the higher the temporally nearer the picture of the inter-predicted blocks is from the motion vectors of which the scene-model points stem, and/or
at a preference varying among the scene-model points in a manner so that the preference is the higher the lower the quantizer step size of the inter-predicted blocks is from the motion vectors of which the scene-model points stem.

33. Video decoder of claim 19, configured to
in using the scene model and the video-geometry-related parameters to derive the block inner,
rely on portions of the scene model at a weight which is
higher for portions which stem from motion vectors of inter-predicted blocks coded in the affine mode than for portions which stem from motion vectors of a translatory mode, and/or
higher for portions which stem from motion vectors of inter-predicted blocks whose motion vectors are coded in the data stream individually for these blocks than for to portions which stem from motion vectors of inter-predicted blocks coded in skip, direct or merge mode, and/or
the higher the lower a prediction residual signal coded into the data stream is according to a predetermined measure for the inter-predicted blocks from the motion vectors of which the portions stem, and/or
the higher the temporally nearer the picture of the inter-predicted blocks is from the motion vectors of which the portions stem, and/or
is the higher the lower the quantizer step size of the inter-predicted blocks is from the motion vectors of which the portions stem.

34. Video decoder of claim 19, configured to
in using the scene model and the video-geometry-related parameters to find in the reference picture the corresponding position,
for each pixel in the current block,
determine a scene projection line along which the scene is projected onto the respective pixel of the current block,
determine one finally used point on the scene projection line based on one or more intersection points of the scene projection line with facial areas of a mesh of the scene model, and
project the finally used point onto the reference picture to acquire the corresponding position corresponding to the respective pixel.

35. Video decoder of claim 19, configured to
in using the scene model and the video-geometry-related parameters to find in the reference picture the corresponding pixel,
for each pixel in the current block,
determine a scene projection line along which the scene is projected onto the respective pixel,
determine one finally used point based on one or more points of a point cloud of the scene model falling into a cone or pyramid widening away from the respective pixel and surrounding the scene projection line,
project the finally used point onto the reference picture to acquire the corresponding position corresponding to the respective pixel.

36. Video decoder of claim 19, configured to
in using the scene model and the video-geometry-related parameters to derive the block inner,
construct a depth map by, for each pixel of pixels of the current picture, measuring a distance from the respective pixel onto the scene model along which the scene is projected onto the respective pixel so as to determine a depth value of the depth map at the respective pixel,
apply interpolation onto the depth map in order to determine depth values for pixels for which the scene model is not hit or sufficiently close to the scene projection line,
use the depth map and the video-geometry-related parameters to derive the block inner.

37. Video encoder for encoding a video of a scene into a data stream using motion-compensated prediction, configured to
derive, for a current block of a current picture, a predicted block inner by
finding corresponding positions in a reference picture, corresponding to pixels in the current block, using video-geometry-related parameters describing how the scene is projected onto pictures of the video, and
sampling the reference picture at the corresponding positions, and
encode the current block using the predicted block inner.

38. Method for decoding a video of a scene from a data stream using motion-compensated prediction, comprising
deriving, for a current block of a current picture, a predicted block inner by
finding in a reference picture corresponding positions, corresponding to pixels in the current block, using video-geometry-related parameters describing how the scene is projected onto pictures of the video, and
sampling the reference picture at the corresponding positions, and
reconstructing the current block using the predicted block inner.

39. Method for encoding a video of a scene into a data stream using motion-compensated prediction, comprising
deriving, for a current block of a current picture, a predicted block inner by
finding corresponding positions in a reference picture, corresponding to pixels in the current block, using video-geometry-related parameters describing how the scene is projected onto pictures of the video, and
sampling the reference picture at the corresponding positions, and
encode the current block using the predicted block inner.

40. Non-transitory digital storage medium storing a data stream generated by a method according to claim 39.
